(19) United States
(12) Patent Application Publication
(10) Pub. No.: US 2006/0210944 A1
(43) Pub. Date: Sep. 21, 2006

(54) Dental modeling and articulating system and method

(76) Inventors: Yunoh Jung, Sandy, UT (US); Daniel Yonil Jung, Sandy, UT (US)

Correspondence Address: Garron M. Hobson, P.O. Box 1219, Sandy, UT, 84070, US

(21) Appl. No.: 11/361,835

(22) Filed: Feb. 24, 2006

Related U.S. Application Data
(63) Continuation-in-part of application No. 10/606,866, filed on Jun. 26, 2003.
(60) Provisional application No. 60/656,553, filed on Feb. 25, 2005.
(60) Provisional application No. 60/454,216, filed on Mar. 12, 2003.
(60) Provisional application No. 60/393,160, filed on Jul. 1, 2002.

(51) Int. Cl. A61C 11/00; A61C 19/00

(52) U.S. Cl. 433/57; 433/59

(57) ABSTRACT

A dental articulating system to duplicate a patient's teeth for producing a dental prosthesis includes a pair of trays pivotally coupled together. A plurality of registration pins is disposable in a plurality of registration pin holes formed in at least one of the trays. A thin cover is disposed across a registration pin hole to close off the registration pin hole and resist dental casting material from substantially filling the registration pin hole. The thin cover is breakable by a registration pin inserted into the registration pin hole. A stop rod opening can be formed in a tray base or model base adjacent the hinge end. A posterior stop rod can be slidable into and securably disposable in the stop rod opening. The stop rod can have an end configured to provide a physical stop between the model bases to retain a desired occlusal relationship between the model bases.

This application claims the benefit of U.S. Provisional Patent Application No. 60/656,553 filed Feb. 25, 2005; and is a continuation-in-part of U.S. patent application Ser. No. 10/606,866, filed Jun. 26, 2003, which claims the benefit of U.S. Provisional Patent Application Nos. 60/454,216, filed Mar. 12, 2003, and 60/393,160, filed Jul. 1, 2002; all of which are herein incorporated by reference.

This application is related to U.S. patent application Ser. No. ______, filed Feb. 24, 2006, which is herein incorporated by reference.

### BACKGROUND OF THE INVENTION

1. Field of the Invention

The present invention relates generally to dental modeling and articulating systems and methods.

2. Related Art

The production of a dental prosthesis requires the production of a working dental model that is a substantially exact duplication of the patient's mouth, and upon which the prosthesis can be fabricated. Such dental prostheses can include crowns, bridges, caps (substructure) for CAD/CAM production, inlays, onlays and other restorative dental works.

In one method of making a dental model, the model is poured, allowed to harden, separated and trimmed; then holes are placed in the lower surface of the cast followed by inserting the pin with glue and placing the cast into a second-pour stone base. The disadvantages of this process include: time consuming, troublesome dowel pin setup, and multiple pours of casting material to create a base and a die. Moreover, this method often involves guesswork, since this method requires the technician to hand occlude two separate casts manually to set the bite. As a result, it is not always possible to relate the mandibular and maxillary casts with one another in such a way as to reproduce an accurate three-dimensional model showing the bites as they were provided by the dentist at the time the negative impression was made.

In another method, a pre-manufactured disposable plastic dental model tray base replaces the stone base mentioned above, so the second pour stage is eliminated. As a result, the whole process of making a dental model can be considerably shortened. Moreover, it is possible to mount the model without separating the upper and lower cast from the impression so that the model is mounted with the bite exactly as the impression is provided by the dentist.

Additionally, nearly all dental gypsum materials expand in volume (0.05%-0.35%) after they are mixed with liquid, typically water, that causes them to set. As a result of this expansion of the stone base, a linear stress against the model occurs. It even stretches apart each sectioned area of the model based upon the degree of expansion. By contrast, a pre-manufactured disposable plastic dental model tray base, which can easily be manufactured by plastic injection molding, intrinsically offers no linear expansion.

For these reasons, pre-manufactured disposable plastic dental model tray bases have become common in plastic disposable articulating systems, especially where double bite/side impressions are mounted on the disposable articulators with a built-in hinge. However, it is estimated that a minimum of 30% of all full arch impressions are single bite/side impressions. A single bite/side impression is one that has only one side (upper or lower teeth, not both) of a negative impression on which the prepped tooth is reflected. A hinge-less tray base type of articulator is generally preferred when pouring a single bite/side impression (an impression without the opposing side of the negative impression attached) or when mounting on a conventional metal articulator or on a semi-adjustable/fully-adjustable articulator.

Regardless of whether a stone base type or a tray base type is used, there are two generally known methods of seperably mounting model work to an upper or lower frame of conventional metal articulators or semi-adjustable/fully-adjustable articulators. The first method is the “magnetic connection method” that uses magnetic power to connect the tray base directly to plaster. The magnet can directly contact with a metal plate secured in the plaster material. The problem with this method is that if the magnet is not retained in place, then the magnet can remain stuck to opposing metal hardware or fall off the mounted model. Additionally, the magnetic power needed to sustain the weight of a modeled tray must be strong enough to hold the tray to the articulator, and consequently, the magnet generally must be glued to the model to prevent the magnet from remaining stuck to the articulator when separating the model from the articulator. This fact makes the magnetically attractable models inefficient and more importantly, too expensive to be accepted as a disposable model tray. Examples of this method can be found in U.S. Pat. Nos. 5,730,593, 4,715,815, and 4,538,987.

The second method is the “plastic friction” method, which uses the friction and resilience of a plastic material to releasably connect a pre-manufactured tray base to a mating articulator plate. In this method, the articulator attachment plate can be retained by a frictional connection with the interior wall of the tray base body. Also, the dental model base may be removed from the metal articulator by simply sliding the snap grove past the snap shoulder. The problem with this method is that, due to the inherent characteristics of plastic materials, the connecting area is susceptible to wearing out due to frequent engagement and disengagement of the parts involved during the entire dental prosthesis process, thereby resulting in the possibility of a loosening of the engaging parts. This looseness of parts may be magnified when the working tray base is situated on the upper jaw side of the model. Furthermore, the added weight of dental plaster that connects the tray base to the upper frame of the metal articulator may cause the tray to disengage and fall. Examples of such methods can be found in U.S. Pat. Nos. 5,788,489 and 5,775,899.

Another problem with typical pre-manufactured disposable plastic dental model tray bases is that proper establishment of the alignment and relationship between the tray base and impression is one of the keys to creating an accurate and aesthetically pleasing dental prosthesis. Pouring a double bite/side impression using a tray with a built-in hinge can provide automatic alignment, thus accomplishing the task easily and effectively. However, alignment of a single bite/side impression on a hinge-less tray base can be quite difficult and burdensome as it is extremely difficult to correctly match the center of the prepped tooth to the single corresponding pin hole out of a plurality of pin holes on the pre-manufactured disposable plastic dental model tray base.

Other important aspects of dental modeling should include: 1) accurate, stable and easy repositioning of the sections of the model to their former relationship with the adjacent dies and also with the opposing model; and 2) the reliable registration of the upper and lower castings with respect to one another.

### SUMMARY OF THE INVENTION

It has been recognized that it would be advantageous to develop a dental modeling and articulating system and method that makes accurate, precise and fast dental models from which dental prosthesis elements, such as crowns, bridges, caps (substructure) for CAD/CAM production, inlays, onlays, and other restorative dental works, can be fabricated. In addition, it has been recognized that it would be advantageous to develop a dental articulating system that can retain a desired occlusal relationship between opposing models. In addition, it has been recognized that it would be advantageous to develop a dental articulating system for full arch impressions that are stable.

The invention provides a dental articulating system that can be configured to duplicate at least a portion of a patient's mouth for use in producing a dental prosthesis. The dental articulating system can include a pair of model bases that can be pivotally couplable together. The model bases can carry opposing models of the patient's teeth. The pair of model bases can also include at least one tray base that can receive dental casting material. A stop rod opening can be formed in a tray base or model base adjacent the hinge end. The stop rod opening can slidably receive a posterior stop rod therein. The posterior stop rod can be slidable into and securably disposable in the stop rod opening. The stop rod can have an end configured to provide a physical stop between the model bases to retain a desired occlusal relationship between the model bases.

In another aspect, the invention provides a dental articulating system having a pair of U-shaped trays that can be pivotally coupled together. The trays can pivot with respect to one another between a closed configuration, in which the trays are opposingly spaced-apart from one another; and an open configuration, in which the trays are pivoted away from one another. A hinge can be integrally formed with the trays and positioned between the trays. The hinge can include a pair of lower arms extending from a lower tray, a pair of upper arms extending from an upper tray, and a pair of hinges. Each hinge can be disposed between a different one of the upper and the lower arms.

In yet another aspect, the invention provides for a dental articulating system having a tray base that can receive dental casting material, and can couple to an opposing model. A plurality of elongated registration pin holes can be formed in the tray base to receive registration pins therein. The pin holes can have a depth greater than a width of the pin holes. A thin cover can be disposed across the registration pin holes to close off the registration pin holes and resist dental casting material from entering the registration pin holes. At least one registration pin can be disposed in at least one of the plurality of registration pin holes. The thin cover can be broken by the registration pin inserted into the registration pin hole with the registration pin extending through the thin cover and into the registration pin hole.

In yet another aspect, the invention provides for a dental articulating system having a U-shaped tray with a receiving surface to receive dental casting material and to carry a prepped model of a prepped tooth. A lingual wall can extend upward from the receiving surface along a lingual edge of the U-shaped tray. The receiving surface can be open along a buccal edge of the U-shaped tray.

In yet another aspect, the invention provides for a dental articulating system having a tray base and a plate magnetically coupleable together. The tray base can receive dental casting material, and the plate can be mountable on an articulator. A magnet recess can be carried by either the tray base or the plate, and a ferrous recess can be carried by the other of the tray base or the plate. The magnet recess can receive a magnet element therein and the ferrous recess can receive a ferrous element therein. The magnet recess can have a magnet opening configured to receive the magnet therethrough. The magnet opening can face away from the ferrous recess so that at least a lip is disposed between the magnet recess and the ferrous recess.

In yet another aspect, the invention provides for a dental articulating system having a stabilizing plate that can receive dental putty thereon to secure an impression to the plate. A hinge can be coupled to an end of the stabilizing plate. A tray base can receive dental casting material and can be securably coupleable to the hinge. The hinge can be operable to pivot the tray base and stabilizing plate with respect to one another, and the tray base can have means for removably coupling the tray base to the hinge.

The present invention also provides for a method for forming a dental model, including pressing a registration pin through a thin cover extending across of a plurality of registration pin holes on a tray base so that the registration pin breaks the thin cover and extends through the thin cover and into a registration pin hole. A prepped model of a prepped tooth can be formed on the tray base by disposing dental casting material over the registration pin on the tray base while the registration pin remains in the registration pin hole. The prepped model of the prepped tooth can be configured to receive a dental prosthesis. The position of the registration pin can be maintained in the registration pin hole through the thin cover while the prepped model of the prepped tooth is formed.

The present invention also provides for a method for releasably securing a dental tray base to a dental articulator including securing an adaptor to a tray base. The adapter can have a recess configured to receive either a magnet element or a ferrous element, and the tray base can receive dental casting material. A magnet element or a ferrous element can be placed within the recess in the adaptor and the other of the magnet element or the ferrous element can be placed in a recess on the plate. A plate can be secured to a dental articulator, and the tray base and the plate can be magnetically coupled together. The tray base can also be separated from the plate.

The present invention also provides for a method for creating dental model work on a tray base including detachably connecting the tray base to a hinge coupled to a putty tray having a flexible and resilient material thereon. An impression tray can be secured on the flexible and resilient material. The hinge can be pivoted to move the tray base and the putty tray into a substantially parallel and opposing relationship. The position of the impression tray can be adjusted on the flexible and resilient material so that an occlusal plane of an impression on the impression tray corresponds to the tray base.

The present invention also provides for a method for forming a dental model including securing an impression to a model base having a hinge pivotally coupling the model base with an opposing tray base. Pins can be inserted into pin holes of the tray base. The hinge can be pivoted to move the model base and the tray base into a substantially parallel and opposing relationship. The pins can be allowed to extend into the impressions. The pins can be checked to see whether the pins extend into a desired cavity in the impression.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1a is a perspective view of a dental articulator of a dental modeling system in accordance with an embodiment of the present invention, shown in a closed configuration;

FIG. 1b is a perspective view of the dental modeling system of claim 1, shown in an open configuration;

FIG. 2a is a perspective view of the dental articulator of the dental modeling system of FIG. 1 with a stop rod in accordance with an embodiment of the present invention, shown in a closed configuration;

FIG. 2b is a perspective view of the dental articulator of the dental modeling system of FIG. 1 with a stop rod in accordance with an embodiment of the present invention, shown in a closed configuration;

FIG. 2c is a perspective view of the dental articulator of the dental modeling system of FIG. 1 with a stop rod in accordance with an embodiment of the present invention, shown in a closed configuration;

FIG. 3 is a perspective view of a dental modeling tray of the dental modeling system of FIG. 1;

FIG. 4 is a cross sectional view of the dental modeling tray of FIG. 3 with a registration pin in a registration pin hole;

FIG. 5a is a cross sectional view of the dental modeling tray of FIG. 3;

FIG. 5b is a partial cross sectional view of the dental modeling tray of FIG. 3;

FIG. 6 is a cross sectional view of the dental modeling tray of FIG. 3 with a thin cover extending across a registration pin hole;

FIG. 7a is a cross sectional view of the dental modeling tray of FIG. 3 with a thin cover extending across a top and bottom of a registration hole;

FIG. 7b is a cross sectional view of the dental modeling tray of FIG. 3 with a thin cover extending across a top and bottom of a registration hole;

FIG. 7c is a cross sectional view of the dental modeling tray of FIG. 3 with a thin cover extending across a top and bottom of a registration hole and a registration pin inserted through the top cover and partially into the registration pin hole;

FIG. 7d is a cross sectional view of the dental modeling tray of FIG. 3 with a thin cover extending across a top and bottom of a registration hole and a registration pin inserted through the top cover and substantially into the registration pin hole;

FIG. 7e is a cross sectional view of the dental modeling tray of FIG. 3 with a thin cover extending across a top and bottom of a registration hole and a registration pin inserted through the top and bottom covers and extending through the registration pin hole;

FIG. 8 is a perspective view of a dental articulator of a dental modeling system in accordance with another embodiment of the present invention;

FIG. 9a is a perspective view of a magnet housing of the dental modeling system of FIG. 8;

FIG. 9b is a perspective view of a magnet housing of the dental modeling system of FIG. 8;

FIG. 9c is a perspective view of a plate of the dental modeling system of FIG. 8;

FIG. 10a is an exploded perspective view of a magnetic coupling assembly of the dental modeling system of FIG. 8;

FIG. 10b is an exploded perspective view of a magnetic coupling assembly of the dental modeling system of FIG. 8;

FIG. 11a is an exploded perspective view of a magnet housing and a tray base of the dental modeling system of FIG. 8;

FIG. 11b is a side and top view of the magnetic coupling assembly of FIG. 10a;

FIG. 11c is a side view of the magnetic housing of FIG. 10a;

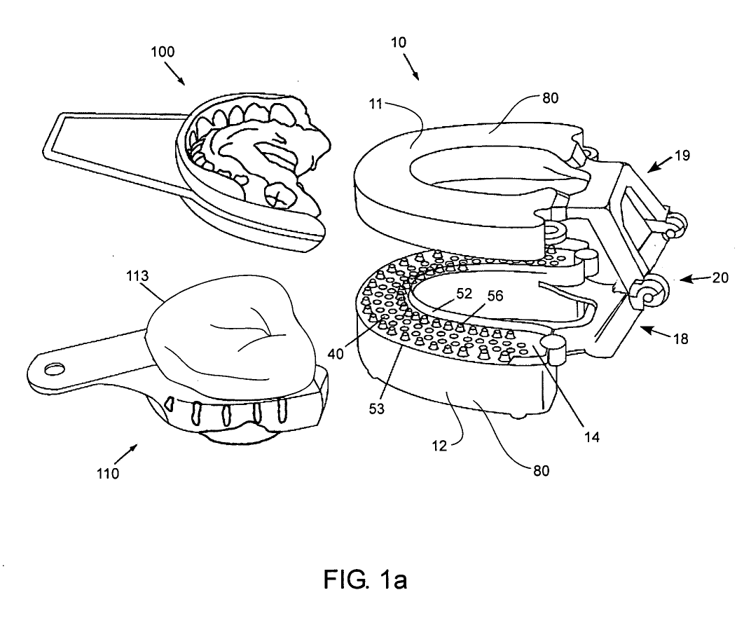

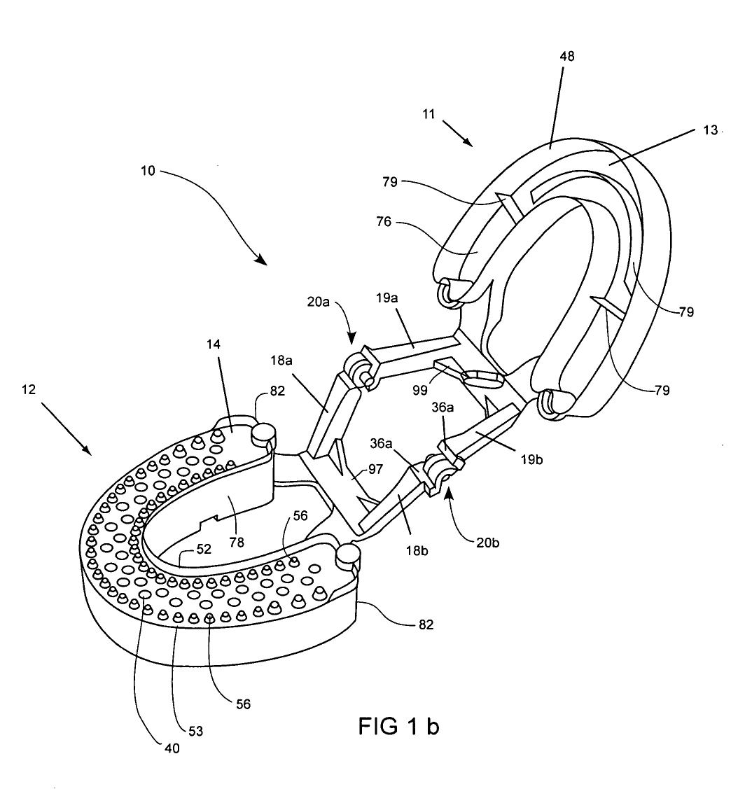

FIG. 1d is a side view of the magnetic coupling assembly of FIG. 10a;

FIG. 12 is a cross section view of the magnetic coupling assembly of FIG. 10a;

FIG. 13 is an exploded perspective view of a dental articulator of a dental modeling system in accordance with another embodiment of the present invention;

FIG. 14 is a perspective view of the dental modeling system of FIG. 13;

FIG. 15 is an exploded perspective view of a dental articulator of a dental modeling system in accordance with another embodiment of the present invention;

FIG. 16 is a perspective view of the dental modeling system of FIG. 15;

FIGS. 17a-17d illustrate a method for forming a dental model in accordance with an embodiment of the present invention; and

FIGS. 18a-18e illustrate a method for forming a dental model in accordance with another embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

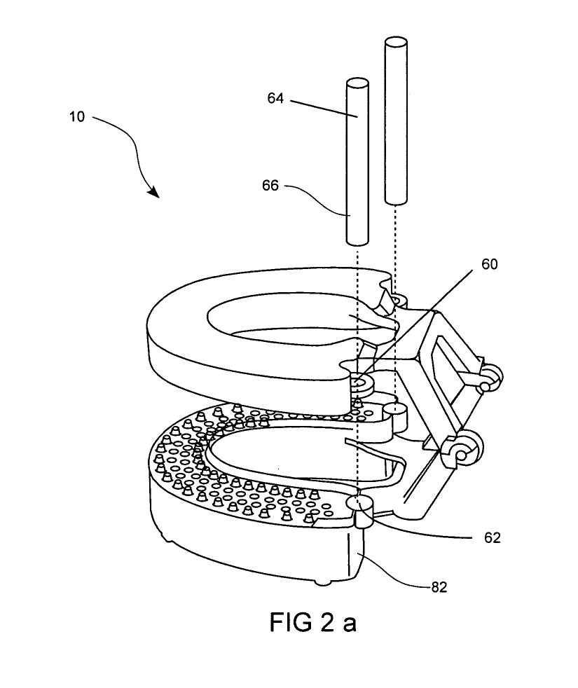

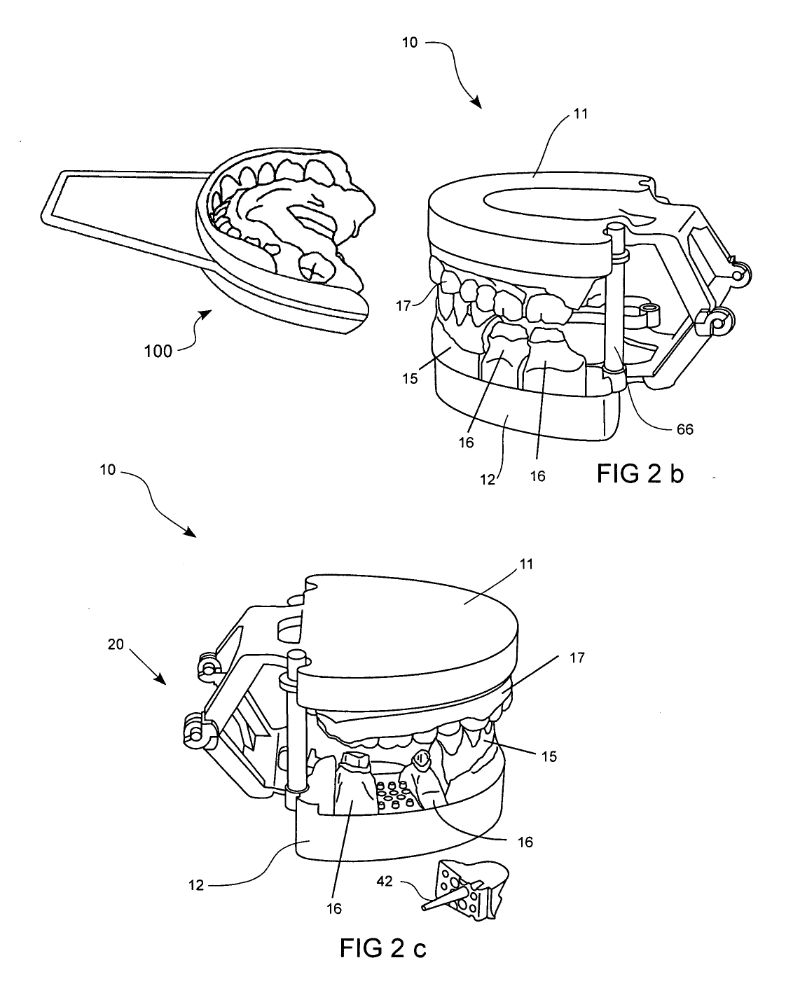

As illustrated in FIGS. 1-2c, a dental modeling and articulating system or device, indicated generally at 10, and its component parts, in accordance with the present invention is shown for use in producing a dental model that is a substantial duplicate of a patient's mouth for use in the production of dental prostheses. Such dental prostheses can include crowns, bridges, caps (substructure) for CAD/CAM production, inlays, onlays, and other restorative works.

The dental modeling and articulating system 10 can be configured to duplicate at least a portion of a patient's mouth for use in producing a dental prosthesis. The dental articulating system 10 can include a pair of model bases 80 that can be pivotally couplable together. The model bases 80 can carry opposing models 15 and 17 (FIG. 2b) of the patient's teeth. The opposing models can include a prosthesis model 15 of the patient's teeth to receive the prosthesis, and an opposing model 17 of the teeth opposite the prosthesis model. The pair of model bases 80 can also include at least one tray base 12, or working tray, that can receive dental casting material to form the prosthesis model. The other model base can be a tray base 11, such as a plastic tray with an opposing model thereon, or a stone base, such as an opposing model formed of dental plaster.

A stop rod opening 60 can be formed in one of the model bases 80, such as the tray base 11. The stop rod opening 60 can be positioned at a hinge end of the tray base. The stop rod opening 60 can slidably receive a posterior stop rod 64 therein. The posterior stop rod 64 can be slidable into and securably disposable in the stop rod opening 60. The stop rod can have an end 66 configured to provide a physical stop between the model bases 80 to retain a desired occlusal relationship between the model bases 80. For example, the stop rod 64 can be inserted through the stop rod opening 60 in the tray base 11 so that the end 66 abuts the other tray base 12, and secured in position with adhesive. It will be appreciated that the stop rod opening can be formed in either tray, or in a stone base.

Advantageously, the stop rod openings 60 allow easy positioning of the stop rods 64 to provide increased stability between the tray bases 80. Thus, the stop rod openings 60 and stop rods 64 make it possible to maintain a correct occlusion, or occlusal relationship between the model bases 80, which produces a much more accurate prosthesis.

Thus, the dental modeling and articulating system 10 can include a working tray 12, and an opposing tray 11. The working tray 12 can hold a cast or model that requires dental prosthesis work. The opposing tray 11 can hold a model of a patient's teeth that opposes the prosthesis work. The working tray 12 and the opposing tray 11 can be pivotally coupled together. Additionally, the working tray 12 can have a working die receiving surface 14, and the opposing tray 11 can have an opposing die receiving surface 13.

The die receiving surfaces 13 and 14 of trays 11 and 12 can receive dental casting material, and dies or models of a patient's teeth. For example, the working tray 12 and working die receiving surface 14 can receive a prepped model 15 or prosthesis die 16 of one or more prepped teeth of a patient. The prepped model 15 can include a model of a prepped tooth, or a prosthesis die 16, to receive a dental prosthesis. Thus, the working tray 12 and working die receiving surface 14 can receive the prepped model 16 of the tooth that will be worked on. The opposing tray 11 and opposing die receiving surface 13 can receive an opposing model or cast 17 of one or more opposing teeth of a patient that oppose the prepped teeth in the prepped model 15. The opposing model can include a model of an opposite tooth opposite the prepped tooth.

It will be appreciated that the working tray 12 can receive a prepped model 15 that can correspond to either the patient's upper or lower teeth. The working tray 12 can be positioned as the lower tray for convenience. Similarly, the opposing tray 11 can receive the opposing model 17 and can be oriented as the upper tray. It will further be appreciated that the working tray 12 and opposing tray 11 can have different configurations than shown or can have similar or the same configurations. Because a majority of dental cases (about 97%) require prosthetics or the like for only the upper or lower side of the mouth, it is typically only necessary to have one working tray 12. However, in cases where both the upper and lower side of the mouth require prosthetics or the like, then two working trays 12 can be coupled together.

The trays 11 and 12 can pivot with respect to one another between a closed configuration, as shown in FIG. 1a, and an open configuration, as shown in FIG. 1b. In the closed configuration, the trays 11 and 12 generally face one another in an opposing, spaced-apart, and parallel relationship, as shown in FIG. 1a. The die receiving surfaces 13 and 14 oppose one another in the closed configuration. In the open configuration, the trays 11 and 12 can pivot away from one another. The closed configuration corresponds to, or models, or imitates a patient's closed mouth, and positions the dies or models of the patient's teeth against one another. The open configuration allows the dies or models of the patient's teeth to be separated for producing dental prosthesis and the like. In addition, the trays 11 and 12 can be detachably connected to allow the trays 11 and 12 to be separated in either the closed or open configurations. The trays 11 and 12 may also be provided separately and connect during or before use.

The trays 11 and 12 can also include a pairs of arms, shown generally as 18 and 19. In the case where the working tray 12 is the lower tray, the pair of arms 18 can be a lower pair of arms, and the pair of arms 19 can be an upper pair of arms. The pairs of arms 18 and 19 can each extend from one of the trays 11 or 12 to a hinge, shown generally at 20. Thus, the pairs of arms 18 and 19 can maintain the trays 11 and 12 in a spaced-apart relationship in the closed configuration. The lower arms 18 can extend upwardly and rearwardly from the working tray 12, while the upper arms 19 can extend downwardly and rearwardly from the opposing tray 11. Thus, the hinge 20 can be positioned behind the trays 11 and 12.

Additionally, the lower pair of arms 18 can include lower arms 18a and 18b, and the upper pair of arms 19 can include upper arms 19a and 19b. A lower brace 97 can extend between the lower arms 18a and 18b and an upper brace 99 can extend between the upper arms 19a and 19b.

The device 10 can also include a pair of separate and discrete hinges 20a and 20b, with the hinge 20a disposed between arms 18a and 19a, and the hinge 20b disposed between arms 18b and 19b. The lower arms 18a and 18b and the upper arms 19a and 19b can also extend laterally outwardly from the trays 11 and 12 so that the pair of hinges 20a and 20b can be spaced-apart from one another. The spaced-apart hinges 20a and 20b can provide additional stability against movement of the trays 11 and 12. The trays 11 and 12 and the pairs of arms 18 and 19 can be integrally formed together.

The trays 11 and 12, and arms 18 and 19, are pivotally and detachably connected by the hinge 20. The hinge 20 can be positioned between the trays 11 and 12, and between the arms 18 and 19. In addition, the hinge 20 can be integrally formed with the trays 11 and 12, and thus with the arms 18 and 19. A portion of the hinge 20 can be carried by each tray or arm. Thus, the hinge 20 can be a two-part hinge with one part formed with the working tray 12 and lower arm 18, and the other part formed with the opposing tray 11 and upper arm 19. In addition, the hinge 20 or parts thereof can snap together for use, as shown in FIGS. 1a and 1b. Thus, the hinge 20 or trays 11 and 12 can be separated if necessary, or joined together by the hinge 20 after the models are disposed in the die receiving surfaces 13 and 14. The arms 18 and 19 and hinge 20 allow the device 10 to mimic or model the open and closing operation of a mouth.

The hinge 20 provides a solid or firm connection between the working tray 12 and the opposing tray 11, and resists undue movement between the trays. It has been found that such a hinge 20 advantageously permits limited movement of the upper tray 11 with respect to the lower tray 12 to simulate the natural movements of the human jaw, including centric, lateral and protrusive movements.

The hinge 20 also allows the opposing tray 11 to be moveable toward and away from the working tray 12. Thus, with dental casts on the working tray 12 and opposing tray 11 it is possible to simulate the opening and closing movement of a patient's jaw. In addition, it is possible to pivot the opposing tray 11 away from the working tray 12 in order to facilitate work on the prosthesis die 16.

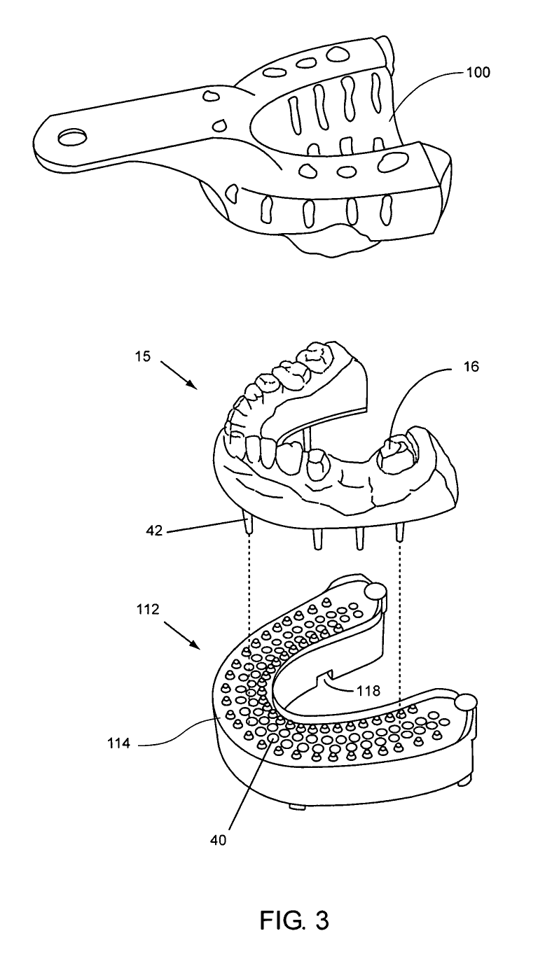

Various aspects of such a hinge are described in U.S. Pat. No. 6,948,932, which is herein incorporated by reference. One or both of the trays 11 and 12 can include an array of registration pin holes 40 for receiving registration pins 42 that can be secured to the casts 15 and 17 as shown in FIGS. 2c and 3.

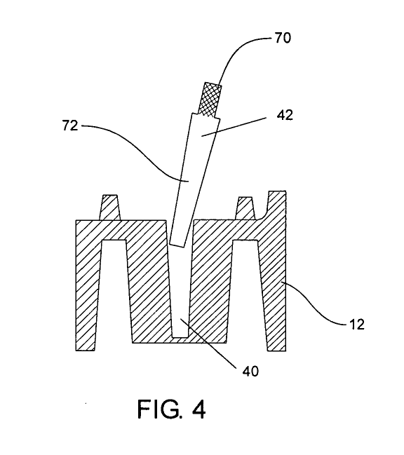

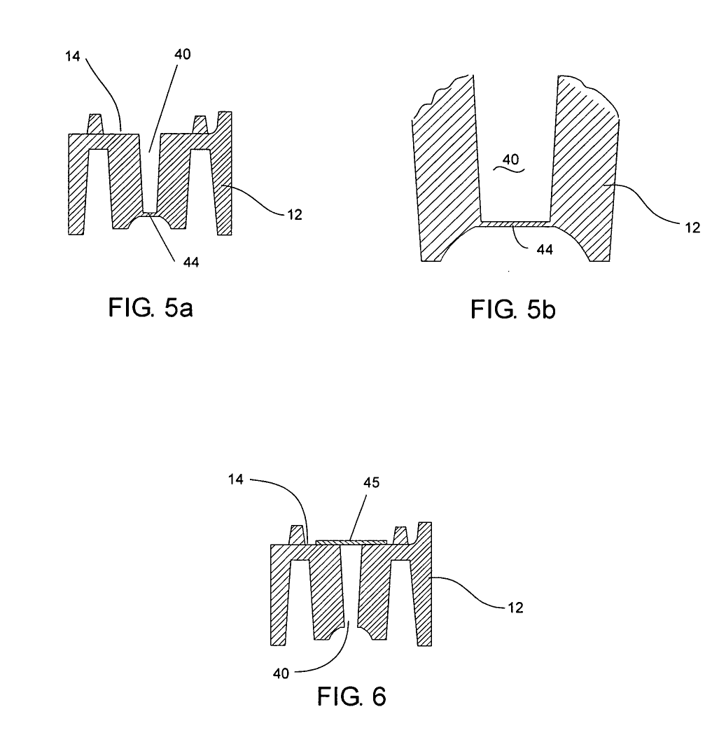

The registration pin holes 40 can be arrayed in two staggered rows, as seen in FIGS. 1a and 1b, centered in the tray 12, and aligned with the curvature of the tray 12. The registration pin holes 40 and the registration pins 42 can be slightly tapered to help seat and secure the pins 42 in the holes 40 so that there is substantially no play or movement between the pin 42 and the hole 40. The registration pin holes 40 can taper inwardly extending into the tray 12 from the die-receiving surface 14 and ending before reaching the bottom pin hole cover 44. The registration pin holes 40 can be arranged in rows extending parallel to the rows of registration struts 56, described in greater detail below. Referring to FIG. 4, a registration pin 42 can be placed into a registration pin hole 40. In one aspect, the registration pin 42 can be a brass dowel pin with a head portion 70 that has a knurled outer surface that can be embedded into the molded cast or model 15 or 17. The other end of the registration dowel pin 42 can be a base portion 72 that has a smooth outer cylindrical or frusto-conical surface that can be inserted into and removed from the registration pin hole 40. Referring to FIGS. 5a-7e, a pin hole cover 44 can be advantageously disposed across one or more of the registration pin holes 40. The pin hole cover 44 can close off the registration pin holes 40 and resist dental casting material from substantially filling the registration pin holes 40, as discussed below. The pin hole cover 44 can include a material and thickness that is breakable or piercable by the registration pin 42 when the pin 42 is inserted into the registration pin hole 40 and forced against the pin hole cover. The pin hole cover 44 can be of sufficient thickness to close the holes 40, and can be of sufficient thinness to be easily pierced by inserting and pushing the registration pin 42 with finger tips from the side of the die-receiving surface 14 to the bottom surface of the tray 12. Alternatively, a tool, or the like, can be used to push the pin 42 through pin hole cover 44. In one aspect, the pin hole cover 44 can have a thickness in the range of about 0.002 to 0.003 inches (0.06 to 0.08 mm).

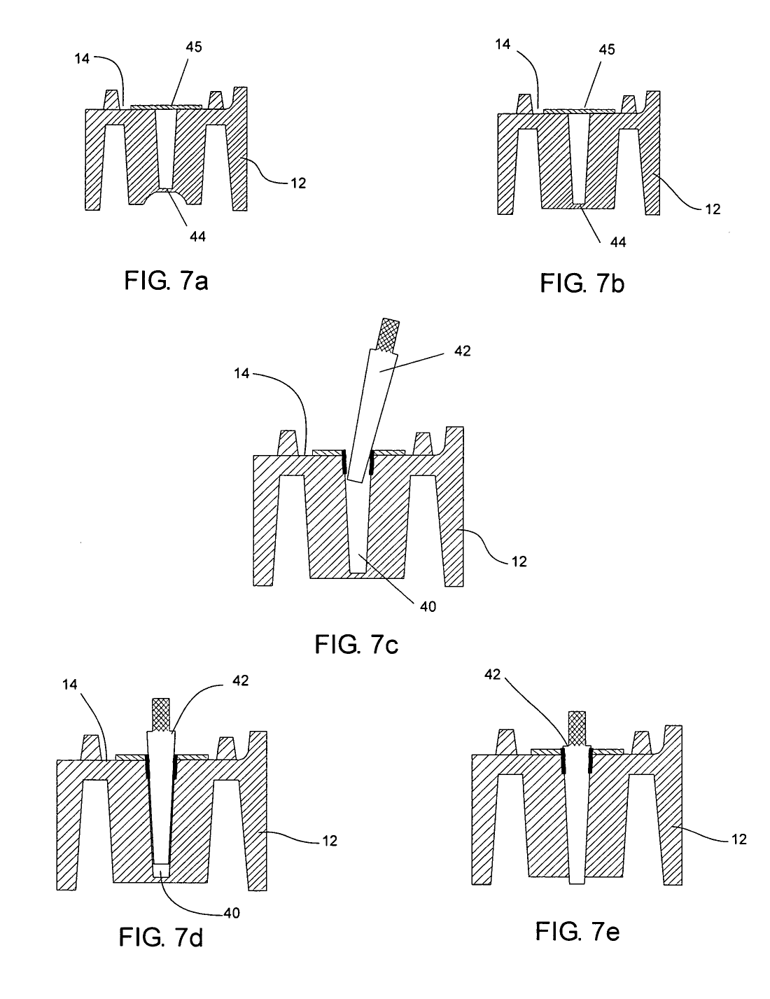

In addition, the pin hole cover 44 can be positioned, and the registration pin 42 can be sized, so that the registration pin 42 extends through the pin hole cover 44, as shown in FIG. 7e. The pin hole cover 44 can be formed of the same material as the tray 12, and can be integrally formed with the tray 12. Integrally forming the cover with the tray secures the cover from moving so that the pin can pierce the cover.

In one aspect, the pin hole cover 44 can be positioned near a bottom of the registration pin holes 40, as shown in FIGS. 3a-3b. Advantageously, a location near a bottom of the registration pin holes 40 can facilitate manufacture during an injection molding process. In another aspect, as shown in FIG. 6, the pin hole cover 44 can be positioned at a top of the registration pin holes 40, and at the die receiving surface 14. Additionally, the pin hole cover 45 can be separately formed from the tray, and attached to the tray. Such a pin hole cover 45 can be attached to the die receiving surface at the top of the registration pin holes 40. The pin hole cover 45 can be attached by adhesive, sonic welding, etc. Positioning the cover 45 above a bottom of the pin hole secures the cover from moving so that the pin can pierce the cover without the cover displacing the cover.

A tray base with covered tapered pin holes provides many advantages as compared to conventional open pin holes. For example, a clean tray base can result in a die completely seating during prosthesis production, which is one of the critical factors in preventing high occlusion for all types of prosthesis work. It will be appreciated that, if untreated, high occlusion can develop into various problems like tooth pain, headache, and distortion of jaw bones. Thus, the pin hole cover of the present invention advantageously reduces the likelihood of high occlusion in a dental prosthesis

Additionally, the action needed to puncture the pin hole cover 44 with a registration pin 42 requires a certain degree of pressure to be placed on the pin 42. This pressure placed on the pin 42 naturally ensures that the pin 42 will positively seat in the pin hole 40 as the pin 42 breaks the cover 44 and extends through the cover 44 and locks into place in the pin hole 40. Having the pin 42 “snugly secured” in this manner helps ensure that segmented dies stay on the tray base 80 and do not fall out, especially in situations when a prosthesis die is located on the upper tray 11. Segmented dies in conventional pin holes without covers can be very susceptible to falling out. This creates a possibility of inadvertently damaging the dies or prosthesis work, since the pins 42 have just been slidingly, and not securely, engaged within the pin hole 40.

It will be appreciated that the pin hole covers 44 and 45 can be positioned at both the bottom of the registration pin holes 44 and at the top of the registration pin holes 45 as shown in FIGS. 7a-7e, thereby providing the several advantages to the device 10 of the present invention. For example, the pin hole covers 44 or 45 can close the registration pin holes 40 and can provide a distinct advantage over open registration pin holes since open registration pin holes can allow the semi-liquid casting material to creep into the holes when a negative impression filled with the casting material is inverted onto the tray. It will be appreciated that casting material in a hole can get stuck in the hole when the casting material hardens, making the initial release of the segmented dies from the tray support members an arduous and difficult job. Additionally, casting material that has hardened in the holes can break during initial release and continue to chip during subsequently repeated engagement and disengagement of the prosthesis dies to the tray, thus resulting in an excess of tiny debris of casting material that can cause inaccurate re-registration of segmented dies to the tray support member, as well as an improper spatial relationship of the segmented dies with respect to the remainder of the segmented cast.

In contrast, the closed registration pin holes 40 of the present invention, as shown in FIGS. 5a-7e, can resist stone from creeping into the registration pin holes because the pin hole covers 44 and 45 close off the pin holes 40. Thus, the present invention makes the removal of the dies easy and clean, and eliminates the initial die breakage off the tray. Moreover, the top pin hole cover 45 advantageously resists any amount of stone from entering the registration pin holes, and, when punctured by registration pin 42, provides a dental technician with a clear view of where the pin 42, and corresponding prosthesis die, must be inserted on the tray 12 during the subsequent engagement and disengagement of the prosthesis dies.

However, after puncturing the top pin hole cover 45, but prior to inverting the negative impression filled with casting material onto the tray 12, it may be determined, especially with less-experienced technicians, that the incorrect pin hole 40 was chosen in relationship to one or more prepped teeth on the negative impression. Advantageously, with the bottom pin hole cover 44 covering the bottom of the pin hole 40, the technician can easily determine the correct pin position in relation to the prepped tooth on the negative impression by allowing the pin 42 to drop into the pin hole 40 until the bottom of the pin 42 reaches the top of the bottom pin hole cover 44. With the pin 42 nearly completely in place, the position can be verified and the corresponding pin hole cover 44 can then be punctured by the registration pin 42. Additionally, the bottom pin hole cover 44 can create an air pocket in the hole 40 when the impression filled with casting material is inverted onto the tray 12. The air pocket can resist the casting material from creeping into the registration pin hole 40.

Providing a tray with both bottom and top pin hole covers 44 and 45 can eliminate the risk of open pin holes due to inaccurately puncturing the top pin hole cover 45, as described above. Furthermore, the bottom pin hole cover 44 can act as a back up and is never punctured until the pin position has been accurately verified. Thus, advantageously, having both a bottom pin hole cover 44 and a top pin hole cover 45 can keep the die receiving surface of the tray clean, and allow positive, accurate, and solid re-registration of the segmented dies onto the tray support member, resulting in a proper spatial relationship of the segmented dies with respect to the remainder of the segmented cast.

Returning to FIG. 1, as stated above, the working tray 12 can be the model base 80 to receive the prosthesis die 14 which can be a model of the tooth 16 to be worked on, while the opposing tray 11 can be the tray that receives an opposing model 17. Thus, the working tray 12 can receive a model of either the upper or lower teeth of the patient.

The trays 11 and 12 can have an elongated, U-shape to receive models of a patients full tooth arch. In one aspect the U-shape can be open, or have an open space between the ends 82 of the U-shape. Advantageously, the open U-shape facilitates handling and production of the dental prosthesis. Additionally, the U-shape of the tray and the hinge feature can provide multiple benefits in regards to efficiency, including complete compatibility with double bite/side impressions, unobstructed accessibility to the lingual side of the model, and work efficiency by eliminating the process of gluing the separate hinge to the distal part of the tray base.

The opposing tray 11 can be simpler in design, structure and function as compared to the working tray 12. Cases that require prosthesis dies on both the upper and lower teeth at the same time are rare, but in such cases both the upper and lower model bases 80 can be working trays 12. Clinically, less than 3 cases out of 100 cases need prosthesis work for both upper and lower teeth at the same time. However, if prostheses must be prepared for both upper and lower teeth, then two working trays 12 can be connected together. Otherwise, a simpler opposing tray 11 will usually suffice to hold the opposing model with a tight grip. The upper die-receiving surface 13 of the opposing tray 11 can have a recessed trough 76 formed therein with a perimeter wall 48 extending around the tray 11 and forming the trough 76. Gripping ribs 79 can be formed on the surface of the opposing tray 11 to help hold the cast with internal stability after the casting material hardens.

The working tray 12 can also include a barrier formed by an inner or lingual side perimeter wall 52. The inner perimeter, or lingual wall 52 can have a flat profile and can extend across the entire inner side 78 of the tray. The outer, or buccal side wall 53 can be made open or without a wall. The lingual wall 52 can create an edge in the model 15 and the prosthesis die 16 to further prevent movement of the models and dies in the trays 12. The flat edge in the model 15 and die 16 can resist chipping, and, thus, resist debris interfering with the fit between the trays 12 and the models 15 and dies. Also, the lingual wall 52 can resist dental plaster from substantially flowing into the inner part of the model, thereby minimizing the amount of dental plaster needed to make a model and making the model easier to form and less time consuming to clean. The open outer wall, or buccal wall 53 can allow the dental casting material to expand freely, thereby preventing distortion that is common when expansion is restricted.

Thus, a tray base 80 a perimeter wall 52 on the lingual side and no wall on the buccal side 53 offers several advantages. For example, the lingual wall 52 can restrict any substantial overflow of the pliant casting material over the edge of the lingual side of the tray base 80. This helps keep the lingual side of the model clean. It will be appreciated that the lingual side of the model can be a hard-to-reach area and would other wise take a considerable amount of time to either clean or grind away plaint casting material that had firmly set and hardened. Moreover, the flat drop off on the buccal side with no wall on the tray base significantly reduces interproximal contact problems associated with stone expansion and distortion of the dental model caused by such expansion. Clinical experiments have shown that allowing the stone to expand freely and unobstructed significantly can reduce distortion of the stone model, thereby leading to a more accurate prosthesis.

The working tray 12 can also include registration struts 56 that can be disposed on the die-receiving surface 14. The struts 56 can be arrayed on either side of the staggered registration pin holes 40, from end to end of the U-shaped tray 12. The registration struts 56 can taper inwardly and upwardly along a length of the strut 56, and can form internally retentive concavities in the cast 15 or 17. The alignment of the struts 56 with the registration pin holes 40 allow each segmented cast or die to have at least one pin 42, and one or more struts 56, even for the small teeth like bicuspids. Thus, the casts 15 can be segmented with the struts 56 and concavities in whole, and not partially sawed apart from the adjacent segments, resulting in maximum registration stability without mesial and distal movement, even for the small teeth like lower anterior teeth. Except for the presence of the registration struts 56 and registration holes 40, the die-receiving surface 14 can be essentially flat and can form a stable planar base for receiving casting stone material thereon for forming a dental cast.

Referring to FIGS. 2a-2c, a stop rod opening 60 can be formed at either or both distal end sides of the U-shaped tray 12. The opening 60 can be directly adjacent the rear area of a stone model 15 or 17, in one of the model bases 80 or trays 11 and 12, while a stop rod receiving area 62 can be formed at either distal end side 82 of the U-shaped tray 12, directly adjacent the rear area of a stone model 15 or 17, in the other of the trays 11 or 12. The opening 60 and receiving area 62 can be formed in a joining area between the tray 12 and the arms 18. A posterior vertical stop rod 64 can be received through each of the opening 60 and can abut to the receiving area 62. The posterior vertical stop rod 64 can be secured in the opening 60 so that the rod 64 can increase stability for free-end posterior prosthesis cases. A free-end posterior prosthesis case is one with non-supporting tooth abutment against the opposing cast at the most distal end (rear area) of the model.

It is important to understand that, in regards to free-end cases, articulators that use a plastic hinge are highly susceptible to inaccuracies in the area of vertical resistance and the occlusal relationship with opposing teeth. This may result in a vertically inaccurate prosthesis, thereby causing various problems such as pain, discomfort, and incomplete chewing that leads to poor digestion. These inaccuracies arise because the hinges/arms are somewhat flexible and can easily be squeezed down in areas where there is no directly adjacent resistance.

Returning to FIG. 1b, general stop members 36a and 36b can keep the overall teeth in a predetermined relationship but do not provide direct resistance at the distal or rearward ends of the model, as is critical. The stop members 36a and 36b also do not provide lateral stability such as to prevent the model from teetering side to side. Both distal ends of the models 15 and 17 can be secured by either a tooth abutment against the opposing cast or, when dealing with a free-end case, a vertical stop rod 64. Advantageously, the free-end vertical stop rod 64 and the opening 60 are provided at the rear areas of a stone model 15 or 17 in order to take the place of distally adjacent teeth, thereby providing the exact occlusal relationship throughout the entire process.

The present invention also provides for a method for forming a dental model, including pressing a registration pin through a thin cover extending across a plurality of registration pin holes on a tray base so that the registration pin breaks the thin cover and extends through the thin cover and into a registration pin hole. A prepped model of a prepped tooth can be formed on the tray base by disposing dental casting material over the registration pin on the tray base while the registration pin remains in the registration pin hole. The prepped model of the prepped tooth can be configured to receive a dental prosthesis. The position of the registration pin can be maintained in the registration pin hole through the thin cover while the prepped model of the prepped tooth is formed.

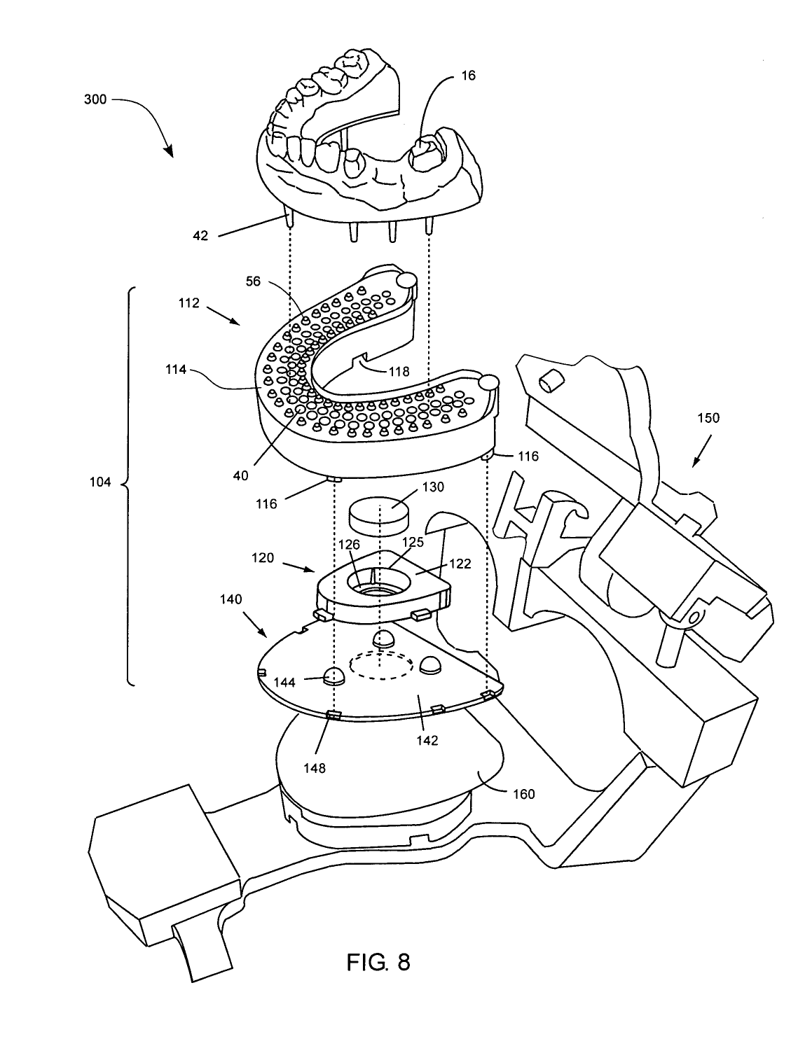

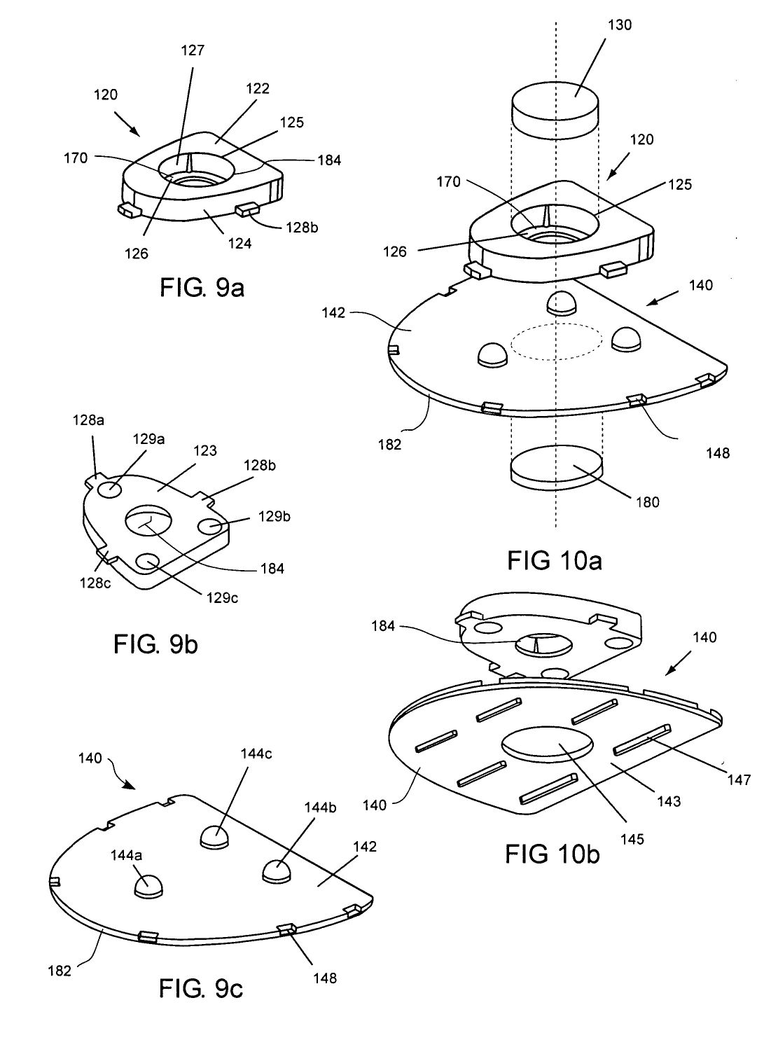

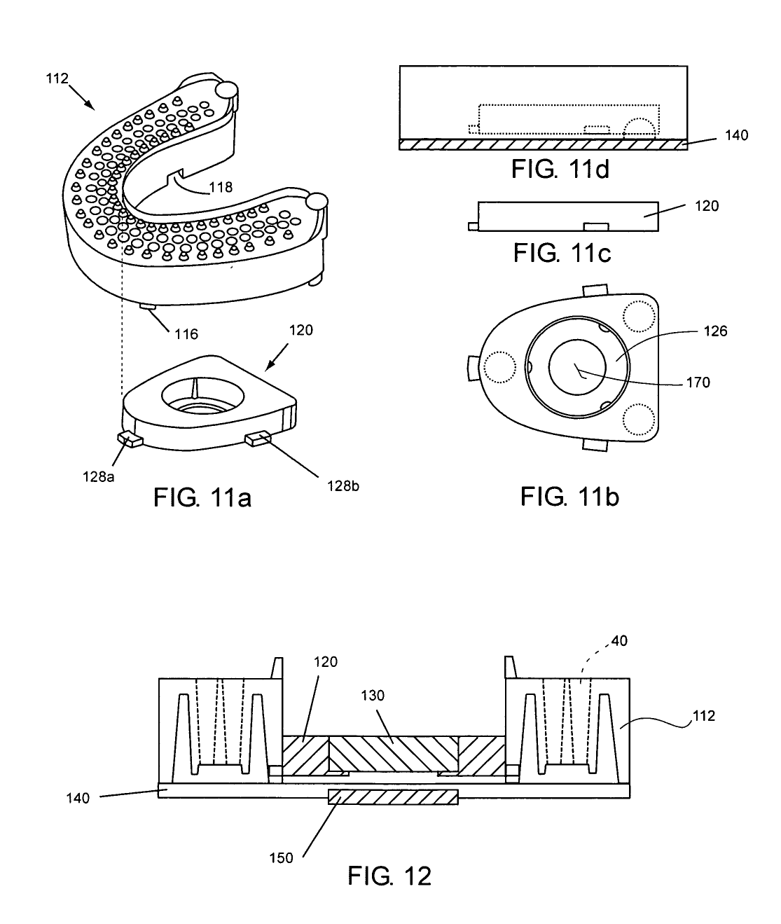

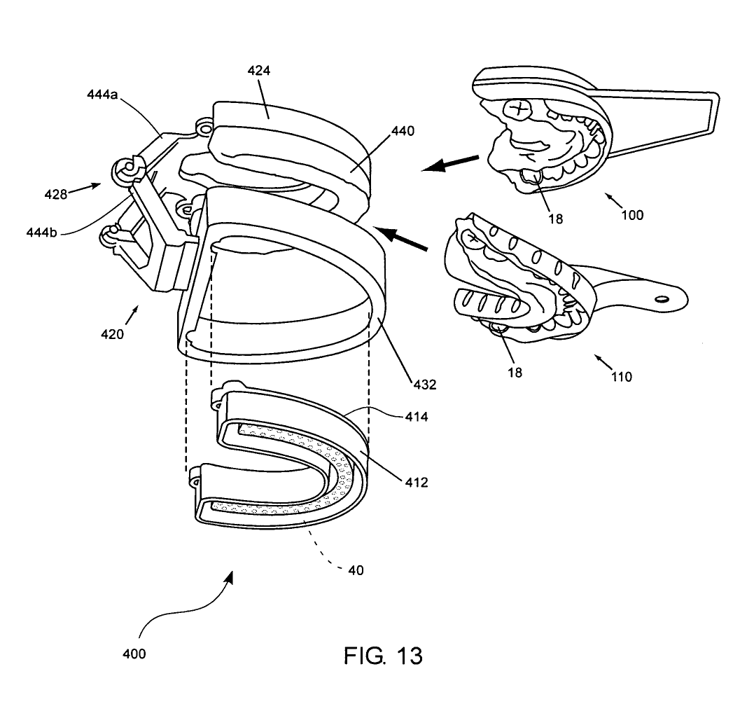

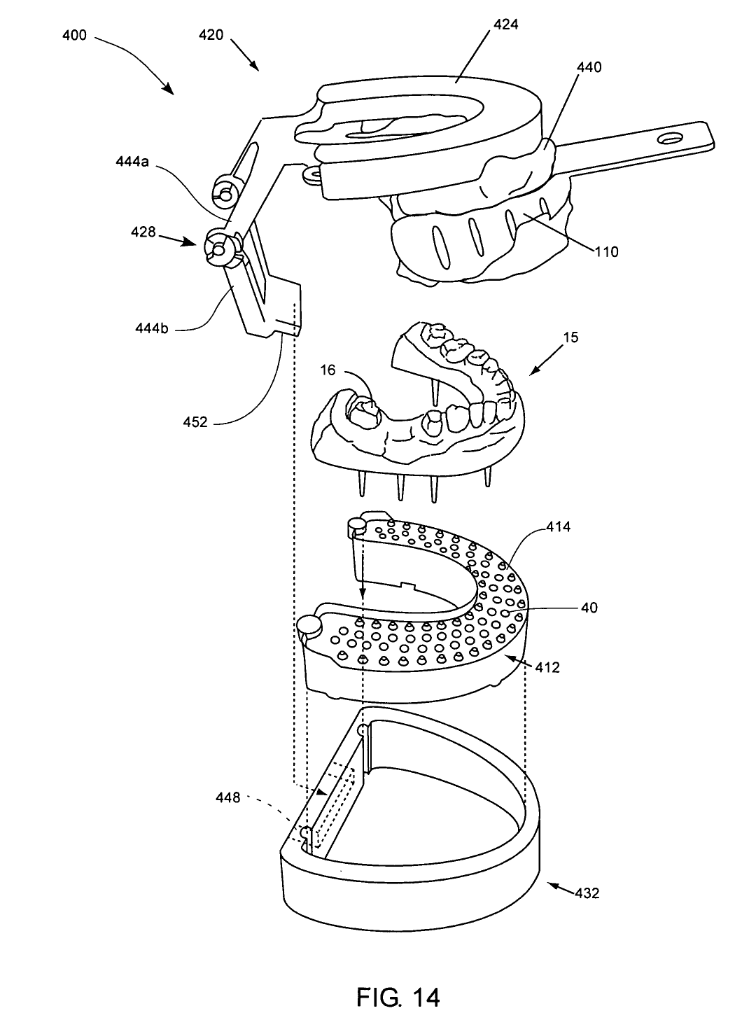

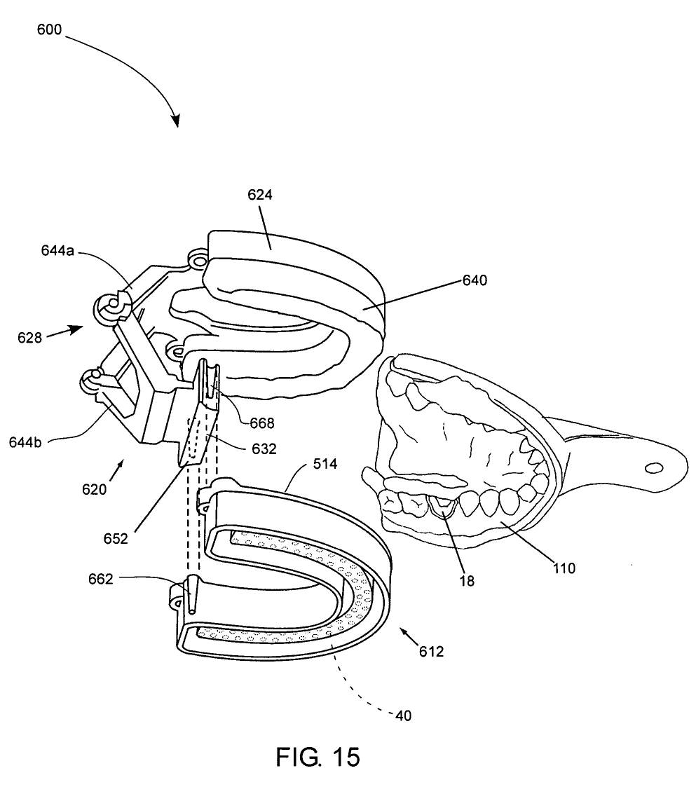

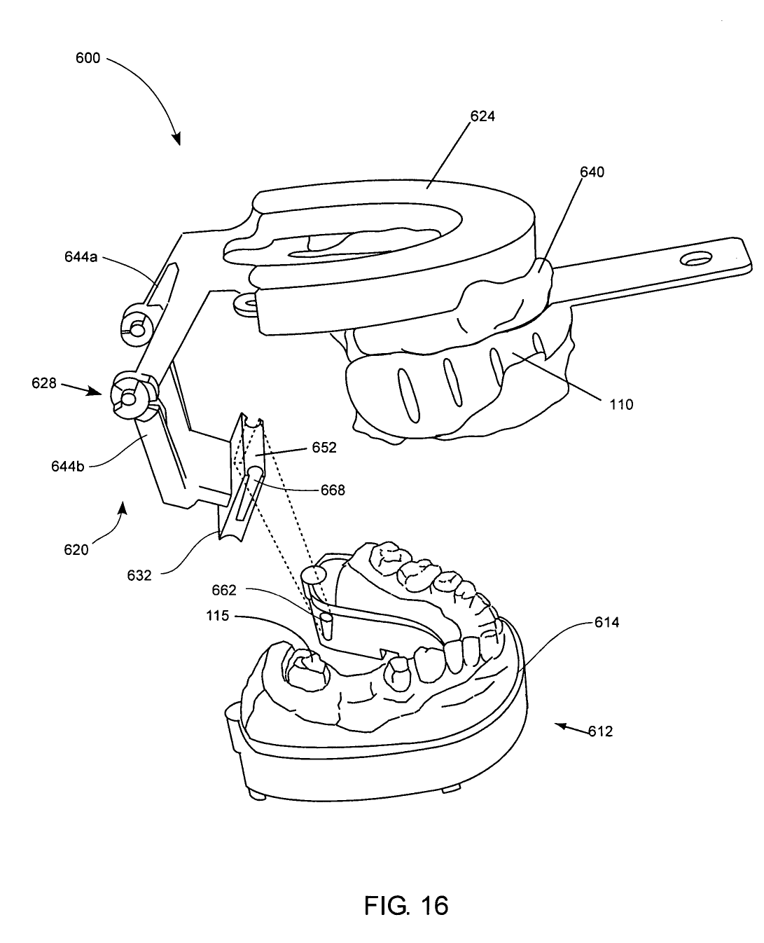

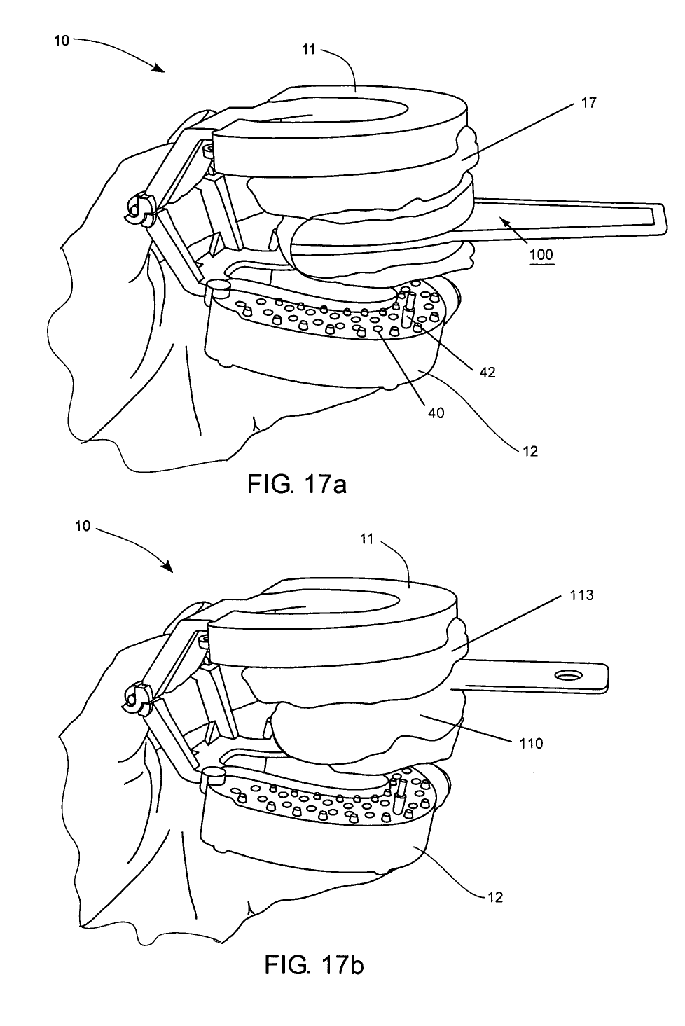

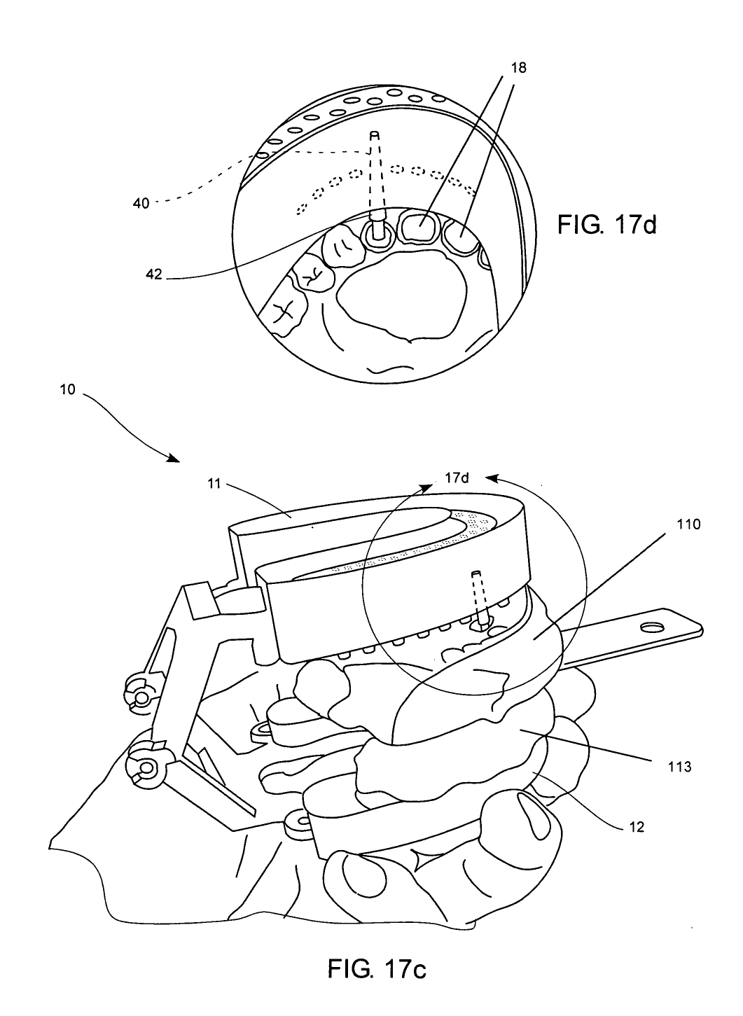

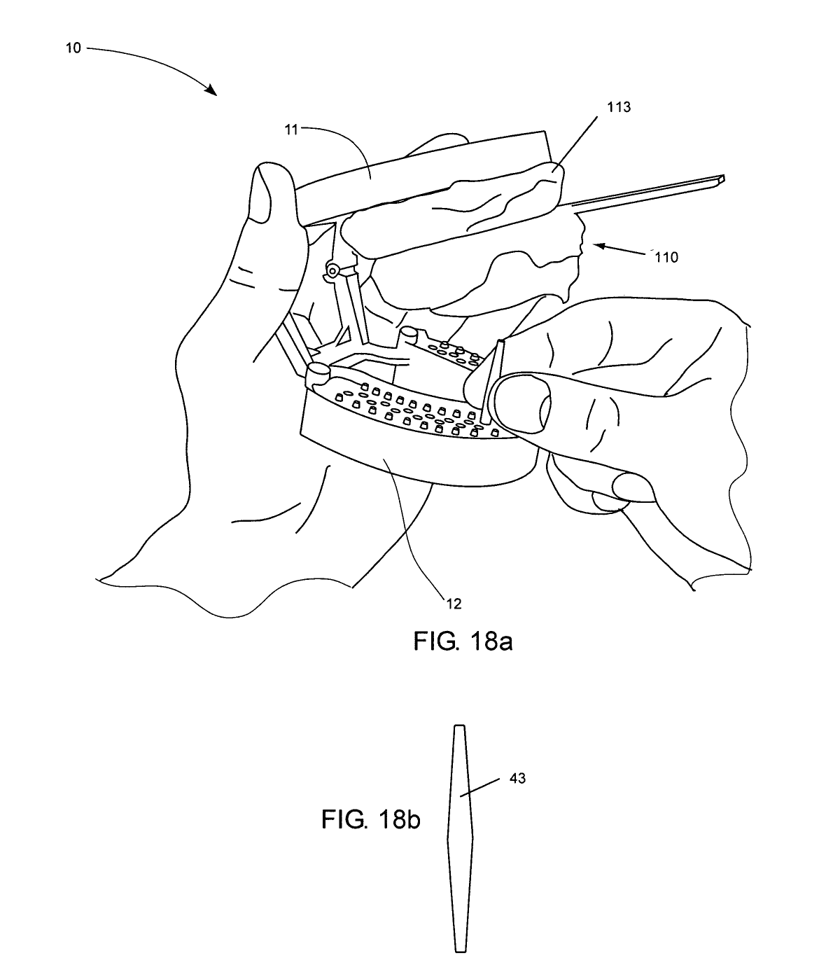

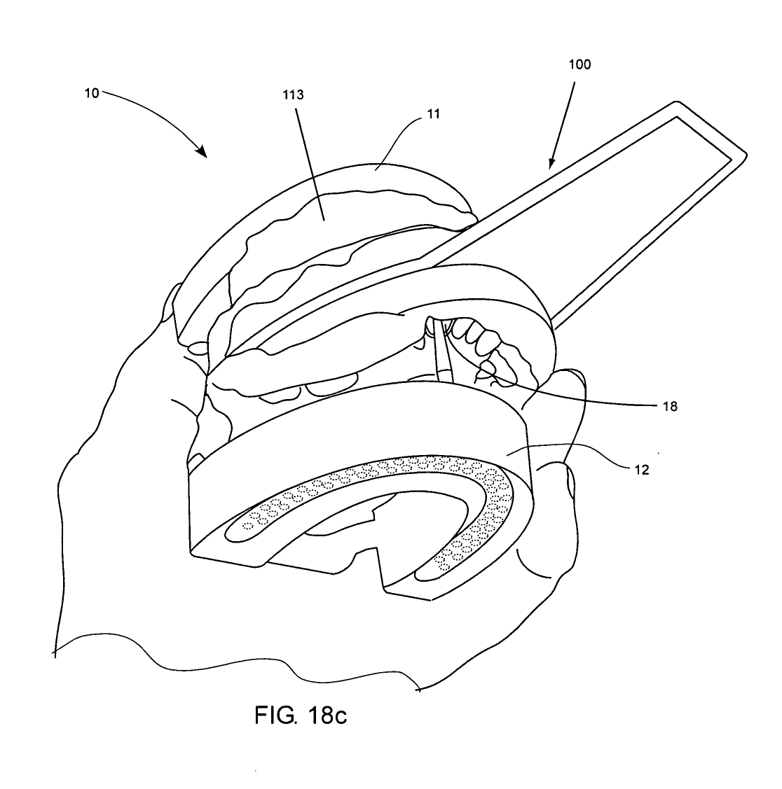

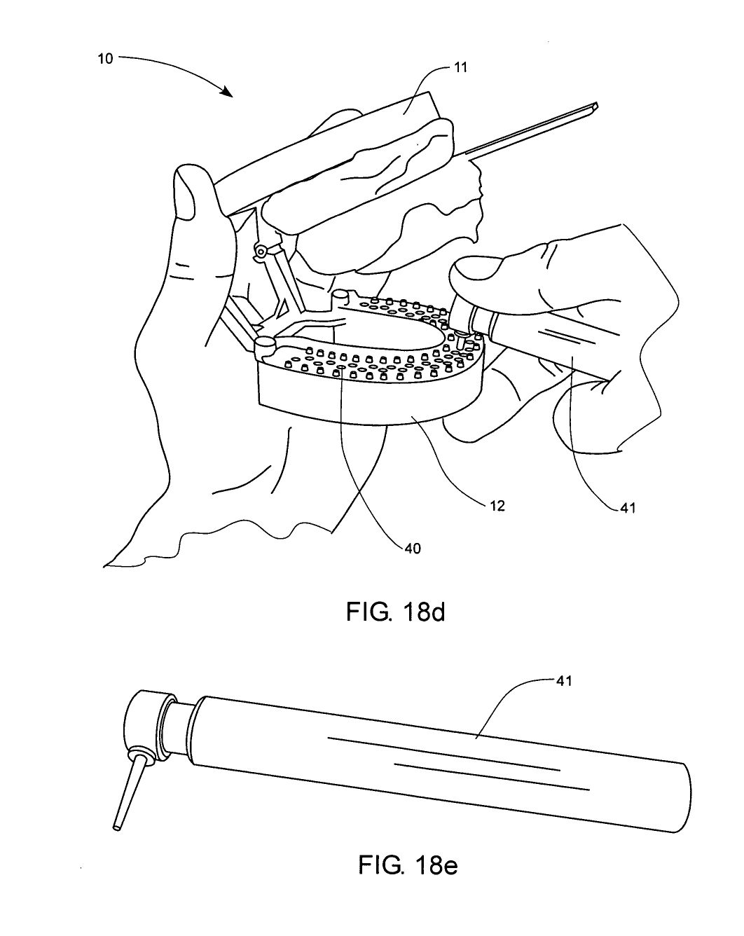

Turning now to FIGS. 8-12, a dental model and articulating system, indicated generally at 300 is shown in accordance with another embodiment of the present invention. The system 300 can have a tray base or tray 112 and a plate, shown generally at 140, magnetically coupleable together. The tray 12 can receive dental casting material, and the plate 140 can mount on an articulator 150. A magnet recess, or inner chamber 125, can be carried by either the tray 112 or the plate 140, and a ferrous recess, or cavity 145, can be carried by the other of the tray 112 or the plate 140. The magnet recess 125 can receive a magnet element, or magnet 130, therein, and the ferrous recess 145 can receive a ferrous element, or metal piece 180, therein. The magnet recess 125 can have a magnet opening 184 configured to receive the magnet 130 therethrough. The magnet opening 184 can face away from the ferrous recess 145 so that at least a lip, or projecting edge 170, is disposed between the magnet recess 125 and the ferrous recess 145.

Thus, the system 300 can have a tray, indicated generally at 112, that can be configured with no pair of arms and without a hinge. The tray 112 can have a die receiving surface 114. Advantageously, the tray 112 and die receiving surface 114 can fill a long felt need for a model base that does not expand linearly and that magnetically attaches and detaches in conjunction with semi or fully adjustable articulators, shown generally at 150, and conventional metal articulators.

The tray 112 can be similar to tray 12 in many respects and the die receiving surface 114 can be similar in regards to the die receiving surface 14, including the struts 56, pin holes 40, and pin hole cover 44 & 45 as described above. Additionally, with the exception of the pair of attached arms and pair of hinges, as previously described, the tray 112 and die receiving surface 114 include all the features of tray 12 and also include a plurality of indentations 118. The indentations 118 can be rectangular and can be sized to precisely receive tabs 128, as described below.

The dental model and articulating system 300 can also have a magnetic tray base assembly, shown generally at 104. The magnetic tray base assembly 104 can include the afore mentioned tray 112 and die receiving surface 114, along with a magnet 130, an adapter or magnet housing, shown generally at 120. The magnetic tray base assembly 104 can also include a metal housing base plate, shown generally at 140, and metal piece, shown generally at 180. In use, when creating a dental prosthesis on a semi or fully adjustable articulator 150, the magnetic tray base assembly 104 can provide the distinct advantage of easier access to both dental models 15 and 17, and to prosthesis dies 16 since the models 15 and 17 and prosthesis dies 16 can be detachable and easily removed from the tray 112 by pushing the pin 42 from the bottom.

The magnet housing 120 or adaptor can include an upper surface 122, a lower surface 123, an outer peripheral wall 124 and an inner chamber 125. The inner chamber 125 can be a cylindrically shaped space which extends from the plane of the upper surface 122 to the plane of the under surface 123.

A magnet 130 can be snugly disposed within the chamber wall 127 and can extend into the inner chamber 125. The magnet 130 can be inserted into the inner chamber 125 from the upper surface 122 and can be pushed down until it meets the resistance of the chamber floor 126. The chamber floor 126 can include a projecting edge 170 that can prevent the magnet 130 from releasing out of the magnet housing 120, as would other wise occur due to the magnetic pull associated with the metal housing base plate 140 and metal piece 180.

In addition, three tabs 128 can protrude from the peripheral wall 124 of the magnet housing 120. Tabs 128b and 128c can be located across from one another on either side of the magnet housing 120. Tab 128a can protrude from the peripheral wall 124 in a location that is equally distant from the tabs 128b and 128c, respectively, and can be located on the convex side of the magnet housing 120. The tabs 128a, 128b and 128c can be rectangular in shape and can correspond precisely to the indentations 118 on the pre-manufactured dental tray base 112, thereby facilitating a secure connection of the magnet housing 120 to the tray base 112. The magnet housing 120 can be permanently attached or separably connected to the tray base 112.

Three conically shaped retention cavities 129a, 129b, and 129c, can be positioned on the under surface 123 of the magnet housing 120. The retention cavities 129b and 129c can be located near the flat side of the peripheral wall next to the tabs 128b and 128c respectively. The retention cavity 129a can be located near the convex side of the magnet housing 120 and next to the tab 128a so that the layout of the three retention cavities form an effectual triangle.

The metal housing base plate 140 can include an upper surface 142 and a lower surface 143. The lower surface 143 can include a circular cavity 145 that can hold a metal piece 180 so that the metal piece 180 can fill the cavity 145. The circular cavity 145 can be located in the center of the metal housing base plate 140 and can correspond with the inner chamber 125 of the magnet housing 120 so that the magnet 130 and the metal piece 150 can be in direct alignment when the magnet housing 120 and the metal housing base plate 140 are magnetically connected as will be discussed below.

Retention bars 147 can be arrayed on the lower surface 143 of the metal housing base plate 140. The retention bars 147 can create a negative depression in the dental plaster when dental plaster is applied to the under surface 143 of the metal housing base plate 140. The retention bars 147, in conjunction with the negative depressions made in the dental plaster 160, can provide stability and retention for the metal housing base plate 140 so that the metal housing base plate 140 can tightly connect to the dental plaster 160, and does not separate or wiggle due to weight of the connecting parts or movement thereof.

Conical retention struts 144 can be positioned on the upper surface 142 of the metal housing base plate 140. The conical retention struts 144 can be located toward the middle of the metal housing base plate 140 and can have the same layout as the retention cavities 129 on the lower surface 123 of the magnet housing 120 in order to receive the retention cavities 129 when mounting a dental model.

Notches 148 can be formed on the upper surface 142 around the curvature and along the outer perimeter 182 of the metal housing base plate 140. The size and rectangular shape of these notches 148 can correspond to the size and shape of the support legs 116 on the lower surface of the tray base 114. The support legs 116 can precisely fit into the notches 148 during connection and disconnection of the tray base 114 to the metal housing base plate 140 and to the articulator. The close fit of the support legs 116 to the notches 148 can provide support and stability, in addition to the retention struts 144 and the retention cavities 129, to the tray base 114 and the prepped dental model 15 in relation to the articulator and opposing dental model.

It will be appreciated that the positions of the magnet 130 and the metal piece 180 can be switched such that the metal piece 180 can be placed in the inner chamber 125 and the magnet 130 can be placed in the circular cavity 145. Accordingly, the inner chamber 125 of the magnet housing 120 can be sized so that the metal piece 150 can fit securely and the circular cavity 145 can be sized so that the magnet 130 can fit securely. Moreover, two magnets 130 can be used in place of a magnet 130 and the metal piece 150 so long as the magnets 130 are placed in the inner chamber 125 and the circular cavity 145 in such a way that the polarity of the magnets 130 attract one another together.

A tray base 80 magnetically connectable to various types of articulators provides several advantages to the present invention. For example, dental technicians can more easily align single bite/side impressions to the tray base 80 which is then releasably connected to a traditional metal articulator or semi/fully-adjustable articulator with magnetic force. This magnetic connection to an adjustable and more anatomically precise articulator enables the technicians to work more closely with the patient's anatomy. Additionally, the magnetic connection provides for easier and more dependable engagement and disengagement of the tray base 80 with the articulator, even after numerous repetitions because the magnetic connection reduces frictional wear and tear. Furthermore, the placement of the magnet 130 in relation to the metal piece 150 reduces the possibility of the tray base 180 sticking to the plate 140 when the tray base 80 and the plate 140 are not properly secured or are misaligned.

Thus, the present invention also provides for a method for releasably securing a dental tray base to a dental articulator including securing an adaptor 120 to a tray base. The adapter can have a recess configured to receive either a magnet element or a ferrous element, and the tray base can receive dental casting material. A magnet element or a ferrous element can be placed within the recess in the adaptor and the other of the magnet element or the ferrous element can be placed in a recess on the plate. A plate can be secured to a dental articulator, and the tray base and the plate can be magnetically coupled together. The tray base can also be separated from the plate.

Turning now to FIGS. 13-14, a dental model and articulating system, indicated generally at 400 is shown in accordance with another embodiment of the present invention. The system 400 can have a tray, indicated generally at 412, that can be similar in many respects to the trays 12 and 112 described above. The tray 412 can have a die receiving surface 414 that can be similar in many respects to the die receiving surface 14, including the struts 56, pin holes 40, and pin hole covers 44 & 45, as described above. Additionally, the system 400 can have an aligning fixture, shown generally at 420, including a stabilizing plate 424, a connector hinge 428, and an adapter 432.

The stabilizing plate 424 can have an upper surface that is sufficiently large enough to balance and support a single side bite impression 110 or a double side bite impression 100 throughout the process of making a prepped model. The surface of the stabilizing plate 424 can receive a tacky material such as putty 440 for the purpose of separably connecting the impression 100 or 110 to the stabilizing plate 424.

The connector hinge 428 can include at least one set of hinges 444a and 444b that can allow pivotal movement of the stabilizing plate 424 in relation to the pre-manufactured dental model tray 412, which can be attached to the adapter 432 of the aligning fixture 420 opposite the stabilizing plate 424. Pivotal movement between the stabilizing plate 424 and tray 412 provides a method of efficiently checking and, if necessary, correcting the position of the impression 100 or 110 so that the curved row of teeth are inline to the curved row of pin holes 40 on the tray 412. The at least one set of hinges 444a and 444b extend outwardly in opposing directions. In one direction the hinge 444b extends and is attached to the stabilizing plate 424 and in the other direction the hinge 444a extends and is removably attached to the adapter 432.

The adapter 432 is one means by which the tray 412 can be separably connected to the aligning fixture 420, thereby allowing separable connection to the impression 100 or 110. The adapter 432 can extend around the tray 414 and can provide a means by which the tray 414 may be placed securely there-in, thus temporarily connecting the tray 414 to the aligning fixture 420. A slot, shown by dashed lines at 448, on the adapter 432 can be removably coupled with a tab 452 on the aligning fixture 420.

Turning to FIGS. 15-16, a dental model and articulating system, indicated generally at 600 is shown in accordance with another embodiment of the present invention. The system 600 can have a tray, indicated generally at 612, similar in many respects to the tray 412 described above. The tray 612 can have a die receiving surface 614 that can be similar in many respects to the die receiving surface 414, including the struts 56, pin holes 40, and pin hole covers 44 and 45, as described above. Additionally, the system 600 can have an aligning fixture, shown generally at 620, including a stabilizing plate 624, a connector hinge 628, and an adapter 632.

The stabilizing plate 624 can have an upper surface that is sufficiently large enough to balance and support a single bite, or single side bite impression 110. The upper surface can also be sufficiently large to balance and support a double bite, or double side bite impression 100 throughout the process of making a prepped model. The surface of the stabilizing plate 624 can receive a tacky material such as putty 640 for the purpose of separably connecting the impression 100 or 110 to the stabilizing plate 624.

The connector hinge 628 can include at least one set of hinges 644a and 644b that can allow pivotal movement of the stabilizing plate 624 in relation to the pre-manufactured dental model tray 612, which can be attached to the adapter 632 of the aligning fixture 620 opposite the stabilizing plate 624. Pivotal movement between the stabilizing plate 624 and tray 612 provides a method of efficiently checking and, if necessary, correcting the position of the impression 100 or 110 so that the curved row of teeth are inline to the curved row of pin holes 40 on the tray 612. The at least one set of hinges 644a and 644b extend outwardly in opposing directions. In one direction the hinge 644b extends and is attached to the stabilizing plate 624 and in the other direction the hinge 644a extends and is removably attached to the adapter 632.

The adapter 632 is one means by which the tray 612 can be separably connected to the aligning fixture 620, thereby allowing separable connection to the impression 100 or 110. The adapter 632 can fit snugly on a tab 652 on the alignment fixture 620 and between the two sides 658 of the U-shaped design of the tray 612. Alignment pins 662 can be located on each of the two sides 658 of the U-shaped design of the tray 612 and each pin can fit in a corresponding slot 668 on the adapter 632 to hold the tray 612 snugly on the alignment fixture 620.

Advantageously, the alignment fixtures 420 and 620 of the present invention solve a long-felt need for an accurate alignment method of an impression with the tray base in which it is not necessary to place any additional markings on any location of the tray base or on the impression. It will be appreciated that previous methods of leaving a mark on the impression as a reference for positioning the model base is time consuming and can be somewhat misleading with regards to exactly matching the pin location to the location of a prepped model. In contrast, once the tray base of the present invention is attached to the alignment fixture, the impression can be placed on the putty, and the alignment fixture can be closed so that the tray base and stabilizing plate are substantially parallel in a stable and relative position. Technicians can then locate the correct pin hole by physically looking to see where the pin sits in a pin hole in relation to the corresponding prepped tooth. This process is very exact or accurate since the position of the pin can be verified against the prepped tooth in the impression, thereby reducing uncertainty in pin placement. Additionally, putty in the alignment fixture can also allow the technician to properly position a single side impression so that the occlusal plane of the teeth, as dictated by the balance of the patient's bite in the impression, will be parallel to the tray base once the model is poured.

FIGS. 17a-17c illustrate methods for forming a dental model using the system or devices seen generally at FIGS. 1, 6, and 12 as described above. The methods include forming a prepped model 15 of the prepped teeth on the working tray 12 of a dental articulator 10. In addition to forming a prepped model 15 on the working tray 12, an opposing model 17 of the opposing teeth can be formed on the opposing tray 11 of the dental articulator 10. The prepped model 15 can include a prepped tooth to receive a dental prosthesis, while the opposing model 17 can include a model of an opposing tooth opposite the prepped tooth.

Forming the prepped model 15 and opposing model 17 can also include obtaining a double bite side impression 100 (FIG. 1) of at least some of a patient's teeth. The impression 100 can typically be made by a dentist by placing a formable material onto a tray or the like, and having the patient bite into the formable material, thus leaving a negative impression of the patient's teeth, as is known in the art. The impression can include a prepped side with an impression of the prepped tooth to receive a dental prosthesis, and an opposing side with an impression of the opposite tooth opposing the prepped tooth. Such an impression can typically be provided to the technician.

The impression 100 can be disposed between the opposing and working trays 11 and 12 of the dental articulator 10. Dental casting material can be introduced between the opposing tray 11 and opposing side of the impression 100 to form the opposing model of the opposing tooth. For example, dental casting material can be disposed on the opposing tray 11 and in the opposing side of the impression 100. The opposing side of the impression 100 can be disposed over the opposing tray 11 so that the dental casting material extends there between, and forms the opposing model 17 of the opposing tooth. The side of the impression 100 that has a prepped tooth faces the working tray 12. Regardless of whether the upper teeth or lower teeth are to receive a dental prosthesis, the working tray 12 receives the prepped side of the impression 100.

Similarly, dental casting material can be introduced between the working tray 12 and the prepped side of the impression 100 to form the prepped model 15 of the prepped tooth. For example, the dental casting material can be disposed on the working tray 12 and in the prepped side of the impression 100. The lower tray 12 can be disposed over the prepped side of the impression 100 so that the dental casting material extends there between, and forms the prepped model 15 of the prepped tooth. The impression 100 can be removed from the dental articulator 10 leaving the opposing and the prepped models 17 and 15 on the respective opposing and working trays 11 and 12.

The impression 100 can be inverted over the opposing tray 11 and the opposing model 17 can be formed first. The impression 100 can then be inverted over the lower tray 12, while still attached to the opposing model 17 and upper tray 11, in order to form the prepped model 15. Thus, the resulting prepped and opposing models 15 and 17 can be mounted in the dental articulator with the bite exactly as the impression provided by the dentist.

Alternatively, the prepped model 15 can be formed first, and the opposing model 17 can be formed after. A single side bite impression 110 can be received from a dentist. A single side bite impression is one that includes a prepped side with an impression of the prepped tooth to receive a dental prosthesis and does not include an impression of the opposing side opposite the prepped side. Dental putty 113 can be temporarily attached to the opposing tray 11 and the impression 110 can be temporarily attached to the dental putty 113. The prepped model 15 can then be formed first and, after removing the impression 110 and the putty 113, the opposing model 17 can be formed.

The prepped model 15 can be segmented on sides corresponding to the prepped tooth to form the prosthesis die 16. Thus, the opposing and working trays 11 and 12 can receive respective opposing and prepped models 17 and 15 (as shown in FIG. 2b).

In practice, a dental technician can cut the cast 15 or 17 to separate out and form the master or prosthesis die 16 to be worked on. The cast 15 or 17 can be cut into segments so that each segment has at least one registration pin 42 (or no pins at all if preferred), and at least two internally retentive cavities corresponding to at least two registration struts 56. Segments can be removed and reinserted into their precise location on the tray to reproduce the model of the original impression and the relationship of the opposing and working tray with respect to each other.

In accordance with one aspect of the invention, a dental articulator 10 can be obtained with opposing and working trays 11 and 12 pivotally coupled together by the hinge 20 that can be integrally formed with the trays. Thus, the working tray 12 can be pivoted to the open configuration to allow access to the prosthesis die 16. In addition, the working tray 12 can be pivoted to the closed configuration to check for clearance between the dental prosthesis on the prosthetic die 16 and the opposing model 17.

In accordance with another aspect of the invention, a dental articulator 10 can be obtained with a thin cover 44 and/or 45 extending across registration pin holes 40 in at least one of the trays, such as the lower tray 12. Registration pins 42 can be positioned in registration pin holes 40 in one of the trays, such as the lower tray 12. For example, at least one registration pin 42 can be positioned at a location corresponding to the prepped tooth and the prosthesis die 16. In addition, other registration pins can be positioned on either side of the prosthesis die 16.

The present invention also includes a method for locating the correct pin holes in relation to the prepped tooth and prosthesis die 16 as seen in FIGS. 17a-18b, including approximating the position of the pin 42 simply by looking at the desired prepped tooth 18 in the double bite/side impression 100 or single bite/side impression 110 as it is fixed (temporarily fixed in the case of impression 110) opposite the working tray 12 and then place a pin 42 in the pin hole 40 that appears to be aligned with it, without puncturing the bottom pin cover 44. The articulator 10 can be turned over so that the working tray 12 is on top, thus allowing the pin 42 to slide in the pin hole 40 and drop into the impression 100 or 110. As seen in FIG. 17b, the technician can thereby verify if the pin 42 fell into the desired area of the impression so as to attach the pin 42 to the desired tooth or section of teeth after the dental casting material is dispensed over it. If the pin does not drop into the desired location it can be removed and placed into an adjacent pin hole for further verification. Once the desired position is found the technician can push the pin 42 though the bottom pin cover 44.

The present invention includes another method for locating the correct pin holes in relation to the prepped tooth and prosthesis die 16 as seen in FIGS. 17a-18b, including using an alignment pin 43 that has a substantially longer head than the registration pin 42. Use of the longer alignment pin 43 can eliminate the need to flip the articulator 10 over so that the working tray 12 is on top, thereby allowing the pin to drop into the impression 100 or 110. Instead, the technician can insert the alignment pin 43 into a pin hole 40, without puncturing the bottom pin cover 44, and close the articulator 10 to ensure the head of the alignment pin 43 touches the desired tooth or section of teeth. Once the desired position has been located, the technician can puncture the bottom pin hole cover 44 with the alignment pin 43 and then remove the alignment pin 43 and insert the registration pin 42 into the corresponding pin hole 40. Alternative to puncturing the pin hole cover 44 with alignment pin 43, the technician can remove the alignment pin 43 and mark the top of the pin hole 40 with a marker or the like. After all the pin holes have been located and marked, the bottom pin hole covers 44 can be punctured with a puncturing tool 41 and the registration pins can be inserted into the marked and punctured pin holes. The puncturing tool 41 can have a handle and a head that can be shaped like a pin in order to fit within a pin hole 40 and puncture the thin cover 44. In one aspect, the head of the pin can be a registration pin 42 attached to one end of the handle, as shown in FIG. 18e.

As described previously, the thin covers can be positioned near the bottom of the registration pin hole 40 as with cover 44, at the top of the registration pin hole 40 as with cover 45, or a combination of both.

The prepped model 15 of the prepped tooth can be formed over the registration pin 42 on the tray 12 of the dental articulator. For example, the dental casting material can be poured over the registration pin 42. In addition, the dental casting material can be disposed over the registration pin holes 40 with the thin cover 44 and/or 45 formed separably and/or integrally with the tray and extending across the registration pin holes to resist dental casting material from substantially filling the registration pin holes.

The dental casting material can be disposed in the trays 11 and 12 and the impression 100 by pouring the dental casting material while it is in a semi-liquid state. After the dental casting material substantially hardens, dries, and/or solidifies, the impression 100 can be removed.

The present invention also provides for a method for forming a dental model on tray base 114, which is substantially the same as tray 12, including forming a prepped model 15 of the prepped teeth. An opposing model can eventually be formed to use in conjunction with the prepped model 15 but need not be associated with the following devices used with the current system, and therefore, will not be detailed below.

The prepped model 15 can include a prepped tooth to receive a dental prosthesis. Forming the prepped model 15 can include obtaining an impression 100 or 110. The impression 100 or 110 can typically be made by a dentist by placing a formable material onto a tray or the like, and having the patient bite into the formable material, thus leaving a negative impression of the patient's teeth, as is known in the art. The impression can include a prepped side with an impression of the prepped tooth to receive a dental prosthesis, and in some cases can also include an opposing side with an impression of the opposite tooth opposing the prepped tooth. Such an impression can typically be provided to the technician.

In accordance with one aspect of the invention, a pre-manufactured dental tray 412 can be removably inserted into an adapter 432. The adapter 432 can be removably attached to the aligning fixture 420 on a hinge side that is opposite a stabilizing plate 424, thus pivotally coupling tray base 412 to stabilizing plate 424, temporarily. The adapter 432 can be removably attached to at least one arm that extends to a connector hinge 428 that allows pivotal movement between tray base 412 and stabilizing plate 424. At least one arm 444a can extend from the connector hinge 428 in an opposite direction of the adapter 432 and attach to the stabilizing plate 424. Dental putty 440 can be placed on the stabilizing plate 424 in the direction facing tray 412. An impression 100 or 110 can be placed on the dental putty 440 and can be temporarily fixed to the putty 440 to facilitate pouring the impression 100 or 110 onto tray 412.

In accordance with another aspect of the invention, a pre-manufactured dental tray base 612 can be obtained with connection pins 662 made to removably receive an aligning fixture 620, thus pivotally coupling tray 612 to a stabilizing plate 624. The aligning fixture 620 can include an adapter 652 that has slots 668 that slidably attach with the connection pins 662 on tray 612. The adapter 652 can be attached to at least one arm that extends to a connector hinge 628 that allows pivotal movement between tray 612 and stabilizing plate 624. At least one arm can extend from the connector hinge 644a in an opposite direction of the adapter 652 and attach to the stabilizing plate 624. Dental putty 640 can be placed on the stabilizing plate 624 in the direction facing the tray 612. An impression 100 or 110 can be placed on the dental putty 640 and can be temporarily fixed to the putty 640 to facilitate pouring the impression 100 or 110 onto the tray 612.

The impression 100 or 110, as it is temporarily fixed to the stabilizing plate 624, and the tray 612 can be pivoted about the connector hinge 628. The tray 612 can be pivoted closed and open as necessary to locate and ensure the exact desired position of the impression 100 or 110 before it is temporarily fixed to the putty 640. After which, the tray 612 can be pivoted open in order to introduce casting material to both the tray 612 and the impression 100 or 110, in the same manner as was explained with the tray 12 described above. The tray 612 can then be disposed over the prepped side of the impression 100 or 110 with the dental casting material extending therebetween, thereby forming the prepped model.

As was detailed with tray 12, the trays 412 and 612 can be obtained with pin hole covers 44 and 45. A registration pin 42 can be pressed through the covers 44 or 45 in locations that correspond to the prepped tooth 18 and adjacent sections of the impression 100 or 110.

The impression 100 or 110 can be separated from the model once the dental casting material has substantially dried, hardened, and/or solidified. The trays 412 and 612, including the prepped model 15, can then be detached from the aligning fixtures 420 and 620, respectively, and attached to the magnetic tray base assembly 104.

The present invention also provides for a method for mounting a dental model system on a semi-adjustable articulator including gluing or otherwise fixing a magnet housing 120 to the tray base 114 by inserting the magnet housing 120 into the tray base 114 from the under side so that the tabs 128 on the magnet housing 120 fit securely into the indentations 118. With the magnet housing secure, the magnet 130 can be separably inserted, from the upper surface 122, into the inner chamber 125 of the magnet housing 120. The chamber floor 126 can prevent the magnet 130 from detaching out of the magnet housing due to the magnet force caused by the metal piece 150 that sits below the magnet 130.

In addition, the tray base 114, with the attached magnet 130 and magnet housing 120, can be separably attached from the under surface 123 to the upper surface 142 of the metal housing base plate 140. As detailed above, the retention cavities 129 of the magnet housing 120 can fit snugly and securely over the conical retention struts 144 of the metal housing base plate 140. Moreover, the legs 116 of the tray base 114 can fit snugly and securely into the notches 148 of the metal housing base plate 140.

The metal piece 150 can be inserted, from the under surface 143, into the circular cavity 145 of the metal housing base plate 140. The metal piece 150 and the magnet 130 can create a strong magnetic force such that the magnet housing 120, tray base 114, and, subsequently, the prepped model 15 are securely and separably connected to each other. Plaster 160 can be applied to the under surface 143 of the metal housing base plate to secure the magnetic tray base assembly 104 to semi/fully-adjustable 150 and conventional metal articulator.

The present invention also provides for a method for creating dental model work on a tray base including detachably connecting the tray base to a hinge coupled to a putty tray having a flexible and resilient material thereon. An impression tray can be secured on the flexible and resilient material. The hinge can be pivoted to move the tray base and the putty tray into a substantially parallel and opposing relationship. The position of the impression tray can be adjusted on the flexible and resilient material so that an occlusal plane of an impression on the impression tray corresponds to the tray base.

The present invention also provides for a method for forming a dental model including securing an impression to a model base having a hinge pivotally coupling the model base with an opposing tray base. Pins can be inserted into pin holes of the tray base. The hinge can be pivoted to move the model base and the tray base into a substantially parallel and opposing relationship. The pins can be allowed to extend into the impressions. The pins can be checked to see whether the pins extend into a desired cavity in the impression.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A dental articulating system configured to duplicate at least a portion of a patient's mouth for use in producing a dental prosthesis, the device comprising:
a) a pair of model bases pivotally couplable together and configured to carry opposing models of the patient's teeth;
b) the pair of model bases including at least one tray base configured to receive dental casting material;
c) a stop rod opening, formed in the tray base or one of the model bases adjacent a hinge end; and
d) a posterior stop rod, slidable into and securably disposable in the stop rod opening and having an end configured to abut to one of the model bases to provide a physical stop between the model bases to retain a desired occlusal relationship between the model bases.

2. A system in accordance with claim 1, wherein the posterior stop rod is securable in the stop rod opening with adhesive.

3. A system in accordance with claim 1, wherein the tray base is U-shaped with a stop rod opening formed near an end of each leg of the U-shaped tray; and further comprising two stop rods with each stop rod slidably disposable in one of the stop rod openings.

4. A system in accordance with claim 1, wherein the tray base further includes:
a) a plurality of elongated registration pin holes, formed in the tray base, and operable to receive registration pins therein, and the pin holes having a depth greater than a width of the pin holes;
b) a thin cover, disposed across the registration pin holes, to close off the registration pin holes and resist dental casting material from entering the registration pin holes; and
c) at least one registration pin, disposable in at least one of the plurality of registration pin holes, the thin cover being breakable by the registration pin inserted into the registration pin hole with the registration pin being extendable through the thin cover and into the registration pin hole.

5. A system in accordance with claim 1, wherein the tray base further includes:
a) a U-shaped tray, having a die receiving surface to receive dental casting material and to carry a prepped model of a prepped tooth;
b) a lingual wall, extending upward from the die receiving surface along a lingual edge of the U-shaped tray; and
c) the die receiving surface being open along a buccal edge of the U-shaped tray.

6. A dental articulating system configured to duplicate at least a portion of a patient's mouth for use in producing a dental prosthesis, the device comprising:
a) a pair of U-shaped trays, pivotally coupled together, the trays pivoting with respect to one another between:
i) a closed configuration, in which the trays are opposingly spaced-apart from one another; and
ii) an open configuration, in which the trays are pivoted away from one another; and
b) a hinge, integrally formed with the trays and positioned between the trays, including:
i) a pair of lower arms extending from a lower tray;
ii) a pair of upper arms extending from an upper tray; and
iii) a pair of hinges, each disposed between a different one of the upper and the lower arms.

7. A system in accordance with claim 6, wherein at least one of the U-shaped trays has an open U-shape.

8. A system in accordance with claim 6, further comprising a brace extending between the lower pair of arms and a brace extending between the upper pair of arms.

9. A system in accordance with claim 6, further comprising:
a) a lingual wall, extending upward from a die receiving surface along a lingual edge of at least one of the U-shaped trays; and
b) the die receiving surface being open along a buccal edge of the U-shaped tray.

10. A system in accordance with claim 6, further comprising:
a) a stop rod opening, formed in at least one of the trays adjacent a hinge end; and
b) a posterior stop rod, slidable into and securably disposable in the stop rod opening and having an end configured to abut to one of the trays to provide a physical stop between the pair of U-shaped trays to retain a desired occlusal relationship between the pair of U-shaped trays.

11. A system in accordance with claim 6, wherein at least one of the pair of U-shaped trays further includes:
a) a plurality of elongated registration pin holes, formed in the tray, and operable to receive registration pins therein, and the pin holes having a depth greater than a width of the pin holes;
b) a thin cover, disposed across the registration pin holes, to close off the registration pin holes and resist dental casting material from entering the registration pin holes; and
c) at least one registration pin, disposable in at least one of the plurality of registration pin holes, the thin cover being breakable by the registration pin inserted into the registration pin hole with the registration pin being extendable through the thin cover and into the registration pin hole.

12. A dental articulating system configured to duplicate at least a portion of a patient's mouth for use in producing a dental prosthesis, the device comprising:
a) a tray base, configured to receive dental casting material, and coupleable to an opposing model;
b) a plurality of elongated registration pin holes, formed in the tray base, and operable to receive registration pins therein, and the pin holes having a depth greater than a width of the pin holes;
c) a thin cover, disposed across the registration pin holes, to close off the registration pin holes and resist dental casting material from entering the registration pin holes; and
d) at least one registration pin, disposable in at least one of the plurality of registration pin holes, the thin cover being breakable by the registration pin inserted into the registration pin hole with the registration pin being extendable through the thin cover and into the registration pin hole.

13. A system in accordance with claim 12, wherein each of the pin holes are substantially round, elongate chambers and the thin cover resists dental casting material from substantially filling the elongate chamber.

14. A system in accordance with claim 12, wherein the thin cover is integrally formed with an annular wall surrounding the plurality of elongated registration pin holes.

15. A system in accordance with claim 14, wherein the thin cover is disposed above a bottom of the plurality of elongated registration pin holes.

16. A system in accordance with claim 14, wherein the tray base is a U-shaped tray base having a die receiving surface to receive dental casting material and to carry a prepped model of a prepped tooth; and further comprising a lingual wall, extending upward from the die receiving surface along a lingual edge of the U-shaped tray; and the die receiving surface being open along a buccal edge of the U-shaped tray.

17. A system in accordance with claim 12, wherein the thin cover is separate and discreet from the tray base and attachable to a die receiving surface of the tray base.

18. A method for forming a dental model, comprising the steps of:
a) pressing a registration pin through a thin cover extending across a plurality of registration pin holes on a tray base so that the registration pin breaks the thin cover and extends through the thin cover and into a registration pin hole;
b) forming a prepped model of a prepped tooth on the tray base by disposing dental casting material over the registration pin on the tray base while the registration pin remains in the registration pin hole, the prepped model of the prepped tooth being configured to receive a dental prosthesis; and
c) maintaining a position of the registration pin in the registration pin hole through the thin cover while the prepped model of the prepped tooth is formed.

19. A dental articulating system configured to duplicate at least a portion of a patient's mouth for use in producing a dental prosthesis, the device comprising:
a) a U-shaped tray, having a die receiving surface to receive dental casting material and to carry a prepped model of a prepped tooth;
b) a lingual wall, extending upward from the die receiving surface along a lingual edge of the U-shaped tray; and
c) the die receiving surface being open along a buccal edge of the U-shaped tray.

20. A system in accordance with claim 19, further comprising:
a) a stop rod opening, formed in the tray adjacent a hinge end; and
d) a posterior stop rod, slidable into and securably disposable in the stop rod opening.

21. A system in accordance with claim 19, wherein at least one of the U-shaped trays further includes:
a) a plurality of elongated registration pin holes, formed in the tray, and operable to receive registration pins therein, and the pin holes having a depth greater than a width of the pin holes;
b) a thin cover, disposed across the registration pin holes, to close off the registration pin holes and resist dental casting material from entering the registration pin holes; and
c) at least one registration pin, disposable in at least one of the plurality of registration pin holes, the thin cover being breakable by the registration pin inserted into the registration pin hole with the registration pin being extendable through the thin cover and into the registration pin hole.

22. A system in accordance with claim 19, further comprising:
a hinge, integrally formed with the trays and positioned between the trays, including:
i) a pair of lower arms extending from a lower tray;
ii) a pair of upper arms extending from an upper tray; and
iii) a pair of hinges, each disposed between a different one of the upper and the lower arms.
